(19) United States
(12) Patent Application Publication
(10) Pub. No.: US 2025/0334848 A1
(43) Pub. Date: Oct. 30, 2025

(54) VARIABLE LIGHT TRANSMISSION DEVICE COMPRISING MICROCELLS

(71) Applicant: E INK CORPORATION, Billerica, MA (US)

(72) Inventors: Bryan DUNN, Medford, MA (US); Yu XIA, Acton, MA (US); George G. HARRIS, Woburn, MA (US)

(21) Appl. No.: 19/188,200

(22) Filed: Apr. 24, 2025

Related U.S. Application Data
(60) Provisional application No. 63/640,380, filed on Apr. 30, 2024.

(51) Int. Cl. G02F 1/16757; G02F 1/167

(52) U.S. Cl. CPC G02F 1/16757; G02F 1/167

(57) ABSTRACT

A variable light transmission device is disclosed that mitigates negative aperture diffraction effects and shows good switching speed between the open and the closed optical states. The device comprises a microcell layer disposed between two light transmissive electrode layers, the microcell layer having a plurality of microcells, each microcell including an electrophoretic medium, and each microcell comprising a channel, a protrusion structure, the protrusion structure having one or more concavities.

### RELATED APPLICATIONS

This application claims priority to U.S. Provisional Patent Application No. 63/640,380 filed on Apr. 30, 2024, which is incorporated by reference in its entirety, along with all other patents and patent applications disclosed herein.

### BACKGROUND OF THE INVENTION

This invention relates to a variable light transmission device. Specifically, the invention relates to a microcell electro-optic device comprising an electrophoretic medium comprising electrically charged pigment particles, a charge control agent, and a non-polar liquid. The electrophoretic medium is able to switch between optical states using electric fields. Variable light transmission devices can modulate the amount of light and other electromagnetic radiation passing through them. They can be used on mirrors, windows, sunroofs, and similar items. For example, the device of the present invention may be applied on windows that can modulate infrared radiation for controlling temperatures within buildings and vehicles. Examples of electrophoretic media that may be incorporated into various embodiments of the present invention include, for example, the electrophoretic media described in U.S. Pat. Nos. 7,116,466, 7,327,511, 8,576,476, 10,319,314, 10,809,590, 10,067,398, 10,067,398, and 11,143,930, and U.S. Patent Application Publication Nos. 2014/0055841, 2017/0351155, 2017/0235206, 2011/0199671, 2020/0355979, 2020/0272017, 2021/0096439, and U.S. patent application Ser. No. 17/953,386, filed on Sep. 27, 2022, the contents of which are incorporated by reference herein in their entireties.

Particle-based electrophoretic displays, in which a plurality of electrically charged pigment particles move through a suspending fluid under the influence of an electric field, have been the subject of intense research and development for a number of years. Such displays can have attributes of good brightness and contrast, wide viewing angles, state bistability, and low power consumption when compared with liquid crystal displays.

The terms “bistable” and “bistability” are used herein in their conventional meaning in the art to refer to displays comprising display elements having first and second display states differing in at least one optical property, and such that after any given element has been driven by means of an addressing pulse of finite duration, to assume either its first or second display state, after the addressing pulse has terminated, that state will persist for at least several times, for example at least four times, the minimum duration of the addressing pulse required to change the state of the display element. It is shown in published U.S. Patent Application Ser. No. 2002/0180687 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

As noted above, electrophoretic media require the presence of a suspending fluid. In most prior art electrophoretic media, this suspending fluid is a liquid, but electrophoretic media can be produced using gaseous suspending fluids. Such gas-based electrophoretic media appear to be susceptible to the same types of problems due to particle settling as liquid-based electrophoretic media, when the media are used in an orientation which permits such settling, for example in a sign where the medium is disposed in a vertical plane. Indeed, particle settling appears to be a more serious problem in gas-based electrophoretic media than in liquid-based ones, since the lower viscosity of gaseous suspending fluids as compared with liquid ones allows more rapid settling of the electrically charged pigment particles.

Numerous patents and applications assigned to or in the names of the Massachusetts Institute of Technology (MIT), E Ink Corporation, E Ink California, LLC, and related companies describe various technologies used in encapsulated and microcell electrophoretic and other electro-optic media. Encapsulated electrophoretic media comprise numerous small capsules, each of which comprises an internal phase containing electrophoretically-mobile particles in a liquid medium, and a capsule wall surrounding the internal phase. Typically, the capsules are themselves held within a polymeric binder to form a coherent layer positioned between two electrodes. In a microcell electrophoretic display, the electrically charged pigment particles and the liquid are not encapsulated within microcapsules but instead are retained within a plurality of cavities formed within a carrier medium, typically a polymeric film. The technologies described in these patents and applications include:
(a) Electrophoretic particles, fluids and fluid additives; see for example U.S. Pat. Nos. 5,961,804; 6,017,584; 6,120,588; 6,120,839; 6,262,706; 6,262,833; 6,300,932; 6,323,989; 6,377,387; 6,515,649; 6,538,801; 6,580,545; 6,652,075; 6,693,620; 6,721,083; 6,727,881; 6,822,782; 6,831,771; 6,870,661; 6,927,892; 6,956,690; 6,958,849; 7,002,728; 7,038,655; 7,052,766; 7,110,162; 7,113,323; 7,141,688; 7,142,351; 7,170,670; 7,226,550; 7,230,750; 7,230,751; 7,236,290; 7,277,218; 7,286,279; 7,312,916; 7,382,514; 7,390,901; 7,473,782; 7,561,324; 7,583,251; 7,572,394; 7,576,904; 7,580,180; 7,679,814; 7,848,006; 7,903,319; 8,018,640; 8,115,729; 8,257,614; 8,270,064; 8,363,306; 8,390,918; 8,582,196; 8,654,436; 8,902,491; 8,961,831; 9,052,564; 9,341,915; 9,348,193; 9,361,836; 9,366,935; 9,372,380; 9,382,427; 9,423,666; 9,428,649; 9,557,623; 9,670,367; 9,671,667; 9,688,859; 9,726,957; 9,752,034; 9,765,015; 9,778,535; 9,778,537; 9,835,926; 9,953,588; 9,995,987; 10,025,157; 10,031,394; 10,040,954; 10,061,123; 10,062,337; 10,147,366; and 10,514,583; and U.S. Patent Application Publication Nos. 2003/0048522; 2003/0151029; 2003/0164480; 2004/0030125; 2004/0105036; 2005/0012980; 2009/0009852; 2011/0217639; 2012/0049125; 2013/0161565; 2013/0193385; 2013/0244149; 2013/0063333; 2014/0011913; 2014/0078576; 2014/0104674; 2014/0231728; 2015/0177590; 2015/0185509; 2015/0241754; 2015/0301425; and 2016/0170106;
(b) Capsules, binders and encapsulation processes; see for example U.S. Pat. Nos. 5,930,026; 6,067,185; 6,130,774; 6,262,706; 6,327,072; 6,392,786; 6,459,418; 6,727,881, 6,839,158; 6,866,760; 6,922,276; 6,958,848; 6,987,603; 7,110,164; 7,148,128; 7,184,197; 7,304,634; 7,327,511, 7,339,715; 7,411,719; 7,477,444; 7,561,324; 7,910,175; 7,952,790; 8,129,655; 8,446,664; and U.S. Patent Applications Publication Nos. 2005/0156340; 2007/0091417; and 2009/0122389;
(c) Microcell structures, wall materials, and methods of forming microcells; see for example U.S. Pat. Nos. 6,672,921; 6,751,007; 6,753,067; 6,781,745; 6,788,452; 6,795,229; 6,806,995; 6,829,078; 6,850,355; 6,865,012; 6,870,662; 6,885,495; 6,930,818; 6,933,098; 6,947,202; 7,046,228; 7,072,095; 7,079,303; 7,141,279; 7,156,945; 7,205,355; 7,233,429; 7,261,920; 7,271,947; 7,304,780; 7,307,778; 7,327,346; 7,347,957; 7,470,386; 7,504,050; 7,580,180; 7,715,087; 7,767,126; 7,880,958; 8,002,948; 8,154,790; 8,169,690; 8,441,432; 8,891,156; 9,279,906; 9,291,872; 9,388,307; 9,436,057; 9,436,058; 9,470,917; 9,919,553; and 10,401,668; and U.S. Patent Applications Publication Nos. 2003/0203101; 2014/0050814; and 2016/0059442;
(d) Methods for filling and scaling microcells; see for example U.S. Pat. Nos. 6,545,797; 6,788,449; 6,831,770; 6,833,943; 6,930,818; 7,046,228; 7,052,571; 7,166,182; 7,347,957; 7,374,634; 7,385,751; 7,408,696; 7,557,981; 7,560,004; 7,564,614; 7,572,491; 7,616,374; 7,715,087; 7,715,088; 8,361,356; 8,625,188; 8,830,561; 9,346,987; and 9,759,978; and U.S. Patent Applications Publication Nos. 2002/0188053; 2004/0120024; 2004/0219306; and 2015/0098124;
(e) Films and sub-assemblies containing electro-optic materials; see for example U.S. Pat. Nos. 6,825,829; 6,982,178; 7,110,164; 7,158,282; 7,554,712; 7,561,324; 7,649,666; 7,728,811; 7,826,129; 7,839,564; 7,843,621; 7,843,624; 7,952,790; 8,034,209; 8,177,942; 8,390,301; 9,238,340; 9,470,950; 9,835,925; and U.S. Patent Applications Publication Nos. 2005/0122563; 2007/0237962; and 2011/0164301;
(f) Backplanes, adhesive layers and other auxiliary layers and methods used in displays; see for example U.S. Pat. Nos. D485,294; 5,930,026; 6,120,588; 6,124,851; 6,177,921; 6,232,950; 6,252,564; 6,312,304; 6,312,971; 6,376,828; 6,392,786; 6,413,790; 6,480,182; 6,498,114; 6,506,438; 6,518,949; 6,545,291; 6,639,578; 6,657,772; 6,664,944; 6,683,333; 6,710,540; 6,724,519; 6,816,147; 6,819,471; 6,825,068; 6,831,769; 6,842,279; 6,842,657; 6,865,010; 6,873,452; 6,909,532; 6,967,640; 7,012,600; 7,012,735; 7,030,412; 7,075,703; 7,106,296; 7,110,163; 7,116,318; 7,148,128; 7,167,155; 7,173,752; 7,176,880; 7,190,008; 7,206,119; 7,223,672; 7,230,751; 7,256,766; 7,259,744; 7,301,693; 7,304,780; 7,327,346; 7,327,511; 7,347,957; 7,365,733; 7,388,572; 7,401,758; 7,492,497; 7,535,624; 7,551,346; 7,554,712; 7,560,004; 7,583,427; 7,649,674; 7,667,886; 7,672,040; 7,688,497; 7,826,129; 7,830,592; 7,839,564; 7,880,958; 7,893,435; 7,905,977; 7,952,790; 7,986,450; 8,034,209; 8,049,947; 8,072,675; 8,120,836; 8,159,636; 8,177,942; 8,237,892; 8,362,488; 8,395,836; 8,437,069; 8,441,414; 8,456,589; 8,514,168; 8,547,628; 8,576,162; 8,610,988; 8,714,780; 8,743,077; 8,754,859; 8,797,258; 8,797,633; 8,797,636; 9,147,364; 9,025,234; 9,025,238; 9,030,374; 9,140,952; 9,201,279; 9,223,164; 9,238,340; 9,285,648; 9,454,057; 9,529,240; 9,620,066; 9,632,373; 9,666,142; 9,671,635; 9,715,155; 9,777,201; 9,897,891; 10,037,735; 10,190,743; 10,324,577; 10,365,533; 10,372,008; 10,446,585; 10,466,565; 10,495,941; 10,503,041; 10,509,294; 10,613,407; and U.S. Patent Applications Publication Nos. 2002/0060321; 2004/0085619; 2004/0105036; 2005/0122306; 2005/0122563; 2006/0255322; 2009/0122389; 2010/0177396; 2011/0164301; 2011/0292319; 2014/0192000; 2014/0210701; 2014/0368753; and 2016/0077375; and International Application Publication Nos. WO2000/038000; WO2000/005704; and WO1999/067678;
(g) Color formation and color adjustment; see for example U.S. Pat. Nos. 6,017,584; 6,545,797; 6,664,944; 6,788,452; 6,864,875; 6,914,714; 6,972,893; 7,038,656; 7,038,670; 7,046,228; 7,052,571; 7,075,502; 7,167,155; 7,385,751; 7,492,505; 7,667,684; 7,684,108; 7,791,789; 7,800,813; 7,821,702; 7,839,564; 7,910,175; 7,952,790; 7,956,841; 7,982,941; 8,040,594; 8,054,526; 8,098,418; 8,159,636; 8,213,076; 8,363,299; 8,422,116; 8,441,714; 8,441,716; 8,466,852; 8,503,063; 8,576,470; 8,576,475; 8,593,721; 8,605,354; 8,649,084; 8,670,174; 8,704,756; 8,717,664; 8,786,935; 8,797,634; 8,810,899; 8,830,559; 8,873,129; 8,902,153; 8,902,491; 8,917,439; 8,964,282; 9,013,783; 9,116,412; 9,146,439; 9,164,207; 9,170,467; 9,170,468; 9,182,646; 9,195,111; 9,199,441; 9,268,191; 9,285,649; 9,293,511; 9,341,916; 9,360,733; 9,361,836; 9,383,623; and 9,423,666; and U.S. Patent Applications Publication Nos. 2008/0043318; 2008/0048970; 2009/0225398; 2010/0156780; 2011/0043543; 2012/0326957; 2013/0242378; 2013/0278995; 2014/0055840; 2014/0078576; 2014/0340430; 2014/0340736; 2014/0362213; 2015/0103394; 2015/0118390; 2015/0124345; 2015/0198858; 2015/0234250; 2015/0268531; 2015/0301246; 2016/0011484; 2016/0026062; 2016/0048054; 2016/0116816; 2016/0116818; and 2016/0140909;
(h) Methods for driving displays; see for example U.S. Pat. Nos. 5,930,026; 6,445,489; 6,504,524; 6,512,354; 6,531,997; 6,753,999; 6,825,970; 6,900,851; 6,995,550; 7,012,600; 7,023,420; 7,034,783; 7,061,166; 7,061,662; 7,116,466; 7,119,772; 7,177,066; 7,193,625; 7,202,847; 7,242,514; 7,259,744; 7,304,787; 7,312,794; 7,327,511; 7,408,699; 7,453,445; 7,492,339; 7,528,822; 7,545,358; 7,583,251; 7,602,374; 7,612,760; 7,679,599; 7,679,813; 7,683,606; 7,688,297; 7,729,039; 7,733,311; 7,733,335; 7,787,169; 7,859,742; 7,952,557; 7,956,841; 7,982,479; 7,999,787; 8,077,141; 8,125,501; 8,139,050; 8,174,490; 8,243,013; 8,274,472; 8,289,250; 8,300,006; 8,305,341; 8,314,784; 8,373,649; 8,384,658; 8,456,414; 8,462,102; 8,514,168; 8,537,105; 8,558,783; 8,558,785; 8,558,786; 8,558,855; 8,576,164; 8,576,259; 8,593,396; 8,605,032; 8,643,595; 8,665,206; 8,681,191; 8,730,153; 8,810,525; 8,928,562; 8,928,641; 8,976,444; 9,013,394; 9,019,197; 9,019,198; 9,019,318; 9,082,352; 9,171,508; 9,218,773; 9,224,338; 9,224,342; 9,224,344; 9,230,492; 9,251,736; 9,262,973; 9,269,311; 9,299,294; 9,373,289; 9,390,066; 9,390,661; and 9,412,314; and U.S. Patent Applications Publication Nos. 2003/0102858; 2004/0246562; 2005/0253777; 2007/0091418; 2007/0103427; 2007/0176912; 2008/0024429; 2008/0024482; 2008/0136774; 2008/0291129; 2008/0303780; 2009/0174651; 2009/0195568; 2009/0322721; 2010/0194733; 2010/0194789; 2010/0220121; 2010/0265561; 2010/0283804; 2011/0063314; 2011/0175875; 2011/0193840; 2011/0193841; 2011/0199671; 2011/0221740; 2012/0001957; 2012/0098740; 2013/0063333; 2013/0194250; 2013/0249782; 2013/0321278; 2014/0009817; 2014/0085355; 2014/0204012; 2014/0218277; 2014/0240210; 2014/0240373; 2014/0253425; 2014/0292830; 2014/0293398; 2014/0333685; 2014/0340734; 2015/0070744; 2015/0097877; 2015/0109283; 2015/0213749; 2015/0213765; 2015/0221257; 2015/0262255; 2015/0262551; 2016/0071465; 2016/0078820; 2016/0093253; 2016/0140910; and 2016/0180777;
(i) applications of displays; see for example U.S. Pat. Nos. 6,118,426; 6,473,072; 6,704,133; 6,710,540; 6,738,050; 6,825,829; 7,030,854; 7,119,759; 7,312,784; 7,705,824; 8,009,348; 8,011,592; 8,064,962; 8,162,212; 8,553,012; 8,973,837; 9,188,829; and 9,197,704; and U.S. Patent Applications Publication Nos. 2002/0090980; 2004/0119681; 2007/0285385; 2013/0176288; 2013/0221112; 2013/0233930; 2013/0235536; 2014/0049808; 2014/0062391; 2014/0206292; and 2016/0035291; and International Application Publication No. WO 00/36560; and
(j) Non-electrophoretic displays, as described in U.S. Pat. Nos. 6,241,921; 6,784,953; 6,795,138; 6,914,713; 6,950,220; 7,095,477; 7,182,830; 7,245,414; 7,420,549; 7,471,369; 7,576,904; 7,580,180; 7,850,867; 8,018,643; 8,023,071; 8,282,762; 8,319,759; and 8,994,705 and U.S. Patent Applications Publication Nos. 2005/0099575; 2006/0262249; 2007/0042135; 2007/0153360; 2008/0020007; 2012/0293858; and 2015/0277160; and applications of encapsulation and microcell technology other than displays; see for example U.S. Pat. No. 7,615,325; and U.S. Patent Application Publications Nos. 2015/0005720 and 2016/0012710.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of a non-polar liquid and a continuous phase of a polymeric material, and that the discrete droplets of electrophoretic medium within such a polymer-dispersed electrophoretic display may be regarded as capsules or microcapsules even though no discrete capsule membrane is associated with each individual droplet; see for example, the aforementioned 2002/0131147. Accordingly, for purposes of the present application, such polymer-dispersed electrophoretic media are regarded as sub-species of encapsulated electrophoretic media.

A related type of electrophoretic display is a so-called “microcell electrophoretic display”. In a microcell electrophoretic display, the electrically charged pigment particles and the suspending liquid are not encapsulated within microcapsules but instead are retained within a plurality of cavities formed within a carrier medium, typically a polymeric film. See, for example, International Application Publication No. WO 02/01281, and published U.S. application Ser. No. 2002/0075556, both assigned to Sipix Imaging, Inc.

Although electrophoretic media are often opaque (since, for example, in many electrophoretic media, the particles substantially block transmission of visible light through the display) and operate in a reflective mode, many electrophoretic displays can be made to operate in a so-called “shutter mode” in which one display state is substantially opaque and one is light-transmissive. See, for example, U.S. Pat. Nos. 6,130,774 and 6,172,798, and 5,872,552; 6,144,361; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode.

An encapsulated or microcell electrophoretic display typically does not suffer from the clustering and settling failure mode of traditional electrophoretic devices and provides further advantages, such as the ability to print or coat the display on a wide variety of flexible and rigid substrates. Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition; and other similar techniques. Thus, the resulting display can be flexible. Further, because the display medium can be printed (using a variety of methods), the display itself can be made inexpensively.

One potentially important market for electrophoretic media is windows with variable light transmission. As the energy performance of buildings and vehicles becomes increasingly important, electrophoretic media could be used on windows to enable the proportion of incident radiation transmitted through the windows to be electronically controlled by varying the optical state of the electrophoretic media. Effective implementation of such “variable transmissivity” (“VT”) technology in buildings is expected to provide (1) reduction of unwanted heating effects during hot weather, thus reducing the amount of energy needed for cooling, the size of air conditioning plants, and peak electricity demand; (2) increased use of natural daylight, thus reducing energy used for lighting and peak electricity demand; and (3) increased occupant comfort by increasing both thermal and visual comfort. Even greater benefits would be expected to accrue in an automobile, where the ratio of glazed surface to enclosed volume is significantly larger than in a typical building. Specifically, effective implementation of VT technology in automobiles is expected to provide not only the aforementioned benefits but also (1) increased motoring safety, (2) reduced glare, (3) enhanced mirror performance (by using an electro-optic coating on the mirror), and (4) increased ability to use heads-up displays. Other potential applications of VT technology include privacy glass and glare-guards in electronic devices.

The art provides examples of devices comprising electrophoretic media sandwiched by electrode layers that are able to achieve a closed optical state (opaque state) and an open optical state (transparent state) and to switch between these states by application of electric fields across the electrophoretic medium. However, conventional electrophoretic devices using conventional structures and waveforms require long switching times. Furthermore, light from a bright object such as a light source in a dark ambient environment or specular reflections of the sun in a bright ambient environment, when it passes through the device may be subject to diffraction phenomena that can be visible or even disturbing to a viewer, making the devices less desirable. The inventors of the present invention unexpectedly found that devices comprising a microcell layer having a plurality of microcells, each microcell of the plurality of microcells having a protrusion structure with one or more concavities achieve efficient switching between the open and close optical states and improved optical performance of the open optical state.

### SUMMARY OF THE INVENTION

In one aspect, the present invention provides a variable light transmission device comprising a first light transmissive electrode layer, a second light transmissive electrode layer, and a microcell layer. The microcell layer comprises a plurality of microcells and a scaling layer. The microcell layer is disposed between the first light transmissive layer and the second light transmissive layer.

Each microcell of the plurality of microcells includes an electrophoretic medium, the electrophoretic medium comprising electrically charged pigment particles, a charge control agent, and a non-polar liquid. Each microcell of the plurality of microcells has a microcell opening, the sealing layer spanning the microcell openings of the plurality of microcells.

Each microcell of the plurality of microcells comprises a microcell bottom layer, a protrusion structure, microcell walls, and a channel, the microcell bottom layer having a microcell bottom inside surface, the microcell bottom inside surface comprising an exposed microcell bottom inside surface and an unexposed microcell bottom inside surface.

The sealing layer of each microcell has an upper surface and a lower surface. The upper surface is in contact with the first light transmissive electrode layer and the lower surface is in contact with the electrophoretic medium.

The protrusion structure has a protrusion base, a total protrusion surface, an exposed protrusion surface, a protrusion apex, a protrusion height, a protrusion volume, and one or more concavities. The protrusion base has a surface. The protrusion apex is a point or a set of points of the protrusion structure, the point or the set of points having shorter distance from the microcell opening than all other points of the protrusion structure. The protrusion apex (219) has a distance from the protrusion base (218). The protrusion height is the distance between the protrusion base and the protrusion apex. The protrusion apex has a surface if the protrusion apex is a set of points. If the protrusion apex is a point, the surface of the protrusion apex is zero. The exposed protrusion surface is the total protrusion surface (i) not including the surface of the protrusion base and (ii) not including any part of the surface of the protrusion apex. The exposed protrusion surface is in contact with the electrophoretic medium. The unexposed microcell bottom inside surface is in contact with the protrusion base. The exposed microcell bottom inside surface is in contact with the electrophoretic medium.

The microcell walls have a microcell inside wall surface and a microcell wall upper surface. The microcell inside wall surface is a surface of the microcell walls of a microcell that is in contact with the electrophoretic medium. The microcell wall upper surface is a surface of the microcell walls that is in contact with the sealing layer.

The channel has a channel height, an inner base perimeter, and an outer base perimeter. The channel height is 50% of the protrusion height. The inner base perimeter is the intersection of the microcell wall and the exposed microcell bottom inside surface. The outer base perimeter is the intersection of the protrusion base and the exposed microcell bottom inside surface. The channel is a volume that is defined by the exposed microcell bottom inside surface, the exposed protrusion surface, the microcell inside wall surface and a plane that is parallel to the microcell bottom inside surface, the plane having a distance from the microcell bottom inside surface equal to the channel height.

The variable light transmission device has a first outside surface and a second outside surface. The first outside surface is located on a side of the variable light transmission device that is near the first light transmissive electrode layer. The second outside surface is located on a side of the variable light transmission device that is near the second light transmissive electrode layer. The second outside surface of the variable light transmission device is closer to the protrusion base than the first outside surface of the variable light transmission device.

Each concavity of the one or more concavities of the protrusion structure is a geometric solid, the geometric solid of each concavity of the one or more concavities having a volume, a height, a depth, and a width. The geometric solid of each concavity has an upper base, a lower base, and a peripheral surface. The lower base of each concavity of the one or more concavities is in contact with the exposed microcell bottom inside surface. The lower base of each concavity of the one or more concavities has a shape selected from the group consisting of an oval, an oval segment, an oval sector, an elliptical segment, an elliptical sector, a circular segment, a circular sector, a triangle, a square, a rectangle, or a polygon having from 5 to 20 sides a circular segment. Each concavity of the one or more concavities is occupied by the electrophoretic medium of the variable light transmission device.

The protrusion volume is a geometric solid. The geometric solid of the protrusion volume is selected from the group consisting of
(a) a polygonal pyramid, the polygonal pyramid having an apex and a polygon base, the polygon base having from 3 to 20 sides, the polygon base being the protrusion base (218) of the protrusion structure (217) and the lower bases (222a) of the one or more concavities (222) of the protrusion structure (217), the apex of the polygonal pyramid being the protrusion apex (219),
(b) a polygonal pyramid frustum, the polygonal pyramid frustum having a first polygon base and a second polygon base, the first polygon base of the polygonal pyramid frustum being the protrusion apex (219), the second polygon base of the polygonal pyramid frustum being the protrusion base (218) and the lower bases (222a) of the one or more concavities (222) of the protrusion structure (217), the first and second polygon bases of the polygonal pyramid frustum having from 3 to 20 sides,
(c) a polygonal pyramid on an polygonal prism, the polygonal pyramid having a polygon base, the polygon base of the polygonal pyramid having a surface area, the polygonal prism having a first polygon base and a second polygon base, the first polygon base having a surface area, the second polygon base having a surface area, the polygon base of the polygonal pyramid being in contact with the first polygon base of the polygonal prism, the surface area of the polygon base of the polygonal pyramid being the same as the surface area of the first polygon base of the polygonal prism, the polygon base of the polygonal pyramid and the first and second polygon bases of the polygonal prism having from 3 to 20 sides, the second polygon base of the polygonal prism being the protrusion base (218) of the protrusion structure (217),
(d) a polygonal pyramid on a polygonal pyramid frustum, the polygonal pyramid having a polygon base, the polygon base of the polygonal pyramid having a surface area, the polygonal frustum having a first polygon base and a second polygon base, the first polygon base of the polygonal pyramid frustum having a first surface area, the second polygon base of the polygonal pyramid frustum having a second surface area, the polygon apex the polygonal pyramid being the protrusion apex (219), the polygon base of the polygonal pyramid being in contact with the first polygon base of the polygonal pyramid frustum, the surface area of the polygon base of the polygonal pyramid being the same as the first surface area of the first polygon base of the polygonal pyramid frustum, the second polygon base of the polygonal pyramid frustum being the protrusion base (218), the polygon base of the polygonal pyramid and the first and second polygon bases of the polygonal pyramid frustum having 3-20 sides,
(e) a first polygonal pyramid frustum on a second polygonal pyramid frustum, the first polygonal pyramid frustum having a first polygon base and a second polygon base, the first polygon base of the first polygonal pyramid frustum having a first surface area, the second polygon base of the first polygonal pyramid frustum having a second surface area, the second polygonal frustum having a first polygon base and a second polygon base, the first polygon base of the second polygonal pyramid frustum having a first surface area, the second polygon base of the second polygonal pyramid frustum having a second surface area, the first polygon base of the first polygonal pyramid frustum being the protrusion apex (219), the second polygon base of the first polygonal pyramid frustum being in contact with the first polygon base of the second polygonal pyramid frustum, the second surface area of the second polygon base of the first polygonal pyramid frustum being the same as the first surface area of the first polygon base of the second polygonal pyramid frustum, the second polygon base of the second polygonal pyramid frustum being the protrusion base (218), the first and second polygon base of the first polygonal pyramid frustum and the first and second polygon base of the second polygonal pyramid frustum having 3-20 sides,
(f) a cone, the cone having an apex and a base, the apex of the cone being the protrusion apex (219), the base of the cone being the protrusion base (218),
(g) a conical frustum, the conical frustum having a first base and a second base, the first base of the conical frustum being the protrusion apex (219), the second base of the conical frustum being the protrusion base (218),
(h) a cone on a cylinder, the cone having an apex and a base, the apex of the cone being the protrusion apex (219), the base of the cone having a surface area, the cylinder having a first base and a second base, the first base of the cylinder having a first surface area and the second base of the cylinder having a second surface area, the base of the cone being in contact with the first base of the cylinder, the surface area of the base of the cone being that same as the first surface area of the first base of the cylinder, the second base of the cylinder being the protrusion base (218),
(i) a cone on a conical frustum, the cone having an apex and a base, the apex of the cone being the protrusion apex (219), the base of the cone having a surface area, the conical frustum having a first base and a second base, the first base of the conical frustum having a surface area, the second base of the conical frustum having a surface area, the base of the cone being in contact with the first base of the conical frustum, the surface area of the base of the cone being the same as the surface area of the first base of the conical frustum, the second base of the conical frustum being the protrusion base (218),
(j) a first conical frustum on a second conical frustum, the first conical frustum having a first base and a second base, the first base of the first conical frustum having a first surface area, the second base of the first conical frustum having a second surface area, the first base of the first conical frustum being the protrusion apex (219), the second conical frustum having a first base and a second base, the first base of the second conical frustum having a first surface area, the second base of the second conical frustum having a second surface area, the second base of the first conical frustum being in contact with the first base of the second conical frustum, the second surface area of the first conical frustum being the same as the first surface area of the first base of the second conical frustum, the second base of the second conical frustum being the protrusion base (218).

The protrusion structure of a microcell may have less than six concavities. The protrusion structure of a microcell may have from 1 to 20 concavities, from 1 to 16 concavities, from 1 to 12 concavities, from 1 to 10 concavities, from 1 to 8 concavities, from 1 to 6 concavities, from 1 to 4 concavities, from 2 to 12 concavities, from 2 to 8 concavities, from 2 to 6 concavities, from 2 to 5 concavities, from 3 to 10 concavities, from 3 to 8 concavities, from 3 to 6 concavities, from 4 to 10 concavities, from 4 to 8 concavities, from 5 to 10 concavities, or from 5 to 8 concavities.

Application of a first electric field between the first light transmissive electrode layer and the second light transmissive electrode layer via a first waveform causes movement of the electrically charged pigment particles towards the channel, resulting in switching of the variable light transmission device to an open optical state. Application of a second electric field between the first light transmissive electrode layer and the second light transmissive electrode layer via a second waveform causes a movement of the electrically charged pigment particles towards the first light transmissive electrode layer, wherein the closed optical state has lower percent transparency than the open optical state. The second waveform may comprise at least one positive voltage and at least one negative voltage, the second waveform having a net positive or net negative impulse. The second waveform may comprise an AC waveform, the AC waveform having a duty cycle of from 5% to 45%. The second waveform may comprise a DC-offset waveform, which is formed by a superposition of a DC voltage component and an AC waveform. The second electric field causes a movement of the electrically charged pigment particles towards the first light transmissive electrode layer with a velocity, wherein the velocity may have a lateral component.

Each microcell of the variable light transmission device of the present invention may have a microcell opening that has a shape, the shape of the microcell opening being selected from the group consisting of a circle, a square, a rectangle, and a polygon, the polygon having 5 to 12 sides. The shape of the microcell opening may be a pentagon, an hexagon, an heptagon, and an octagon. The shape of the microcell opening may be a polygon, the polygon having 9, 10, 11, 12, 13, 14, 15, 16, 17, 18, 19, or 20 sides.

Each microcell of the plurality of microcells of the variable light transmission device of the present invention may have a microcell length of from 400 micrometers to 850 micrometers, from 450 micrometers to 800 micrometers, from 500 micrometers to 750 micrometers, or from 600 micrometers to 740 micrometers. A length of a microcell of the plurality of microcells is defined as the longest distance between any two points of the microcell opening. Each microcell of the plurality of microcells of the variable light transmission device of the present invention may have a microcell height of from 20 micrometers to 100 micrometers, from 20 micrometers to 90 micrometers, from 20 micrometers to 80 micrometers, from 20 micrometers to 60 micrometers, from 20 micrometers to 40 micrometers, from 30 micrometers to 90 micrometers, from 30 micrometers to 80 micrometers, from 30 micrometers to 60 micrometers, from 30 micrometers to 40 micrometers, from 40 micrometers to 80 micrometers, from 40 micrometers to 60 micrometers, from 40 micrometers to 50 micrometers, from 25 micrometers to 40 micrometers, from 50 micrometers to 100 micrometers, or from 50 micrometers to 80 micrometers. Microcell height is the distance between the microcell opening and the microcell bottom inside surface.

Each microcell of the plurality of microcells of the variable light transmission device of the present invention may have a protrusion height of from 15 micrometers to 90 micrometers, from 20 micrometers to 90 micrometers, from 20 micrometers to 80 micrometers, from 20 micrometers to 70 micrometers, from 20 micrometers to 50 micrometers, from 20 micrometers to 30 micrometers, from 30 micrometers to 80 micrometers, from 30 micrometers to 70 micrometers, from 30 micrometers to 50 micrometers, from 30 micrometers to 40 micrometers, from 40 micrometers to 90 micrometers, from 40 micrometers to 50 micrometers, from 30 micrometers to 50 micrometers, from 25 micrometers to 35 micrometers, from 50 micrometers to 90 micrometers, or from 50 micrometers to 70 micrometers. Protrusion height of a protrusion structure of a microcell is the distance between the protrusion base and the protrusion apex of the protrusion structure.

Each concavity of the one or more concavities of a protrusion structure of a microcell of the plurality of microcells of the variable light transmission device of the present invention may have a height of from 15 micrometers to 90 micrometers, from 20 micrometers to 90 micrometers, from 20 micrometers to 80 micrometers, from 20 micrometers to 70 micrometers, from 20 micrometers to 50 micrometers, from 20 micrometers to 30 micrometers, from 30 micrometers to 80 micrometers, from 30 micrometers to 70 micrometers, from 30 micrometers to 50 micrometers, from 30 micrometers to 40 micrometers, from 40 micrometers to 90 micrometers, from 40 micrometers to 50 micrometers, from 30 micrometers to 50 micrometers, from 25 micrometers to 35 micrometers, from 50 micrometers to 90 micrometers, or from 50 micrometers to 70 micrometers. Height of a concavity of a protrusion structure is the longest distance between any point of the concavity to the lower base of the concavity.

Each concavity of the one or more concavities of a protrusion structure of a microcell of the plurality of microcells of the variable light transmission device of the present invention may have a depth of from 5 micrometers to 50 micrometers, of from 5 micrometers to 40 micrometers, of from 5 micrometers to 30 micrometers, of from 5 micrometers to 20 micrometers, of from 5 micrometers to 10 micrometers, of from 10 micrometers to 40 micrometers, of from 10 micrometers to 30 micrometers, of from 10 micrometers to 20 micrometers, of from 15 micrometers to 40 micrometers, of from 15 micrometers to 30 micrometers, of from 15 micrometers to 25 micrometers, of from 20 micrometers to 40 micrometers, of from 20 micrometers to 30 micrometers. Each concavity of the one or more concavities of a protrusion structure of a microcell of the plurality of microcells of the variable light transmission device of the present invention may have a width of from 5 micrometers to 50 micrometers, of from 5 micrometers to 40 micrometers, of from 5 micrometers to 30 micrometers, of from 5 micrometers to 20 micrometers, of from 5 micrometers to 10 micrometers, of from 10 micrometers to 40 micrometers, of from 10 micrometers to 30 micrometers, of from 10 micrometers to 20 micrometers, of from 15 micrometers to 40 micrometers, of from 15 micrometers to 30 micrometers, of from 15 micrometers to 25 micrometers, of from 20 micrometers to 40 micrometers, of from 20 micrometers to 30 micrometers.

A microcell of the plurality of microcells of the variable light transmission device of the present invention may comprise a microcell having a protrusion structure with 2, 3, 4, 5 or 6 concavities. The combination of the protrusion base and the lower bases of the concavities of the microcell forms a first geometric shape, the first geometric shape having a center. The protrusion base may have a Cn symmetry about a symmetry axis, the symmetry axis being vertical to the plane of the protrusion base and passing through the center of the first geometric shape, n being the number of the concavities of the protrusion structure. Cn symmetry means that rotation around the symmetry axis through an angle of 360°/n leaves the protrusion base indistinguishable from the protrusion base before the rotation. The center of a geometric shape is also called “centroid” of the geometric shape, and it is defined as the point where a geometric shape would balance if it were a uniform thin plate. The protrusion base of one or more microcells of the device may have a Cn symmetry about a symmetry axis as described above.

A microcell of the plurality of microcells of the variable light transmission device of the present invention may comprise a microcell having a protrusion structure with 2, 3, 4, 5 or 6 concavities. The combination of the protrusion base and the lower bases of the concavities of the microcell forms a first geometric shape, the first geometric shape having a center. The protrusion base may lack a Cn symmetry about a symmetry axis, the symmetry axis being vertical to the plane of the protrusion base and passing through the center of the first geometric shape, n being the number of the concavities of the protrusion structure. Cn symmetry means that rotation around the symmetry axis through an angle of 360°/n leaves the protrusion base indistinguishable from the protrusion base before the rotation. The protrusion base of one or more microcells of the device may lack a Cn symmetry about a symmetry axis as described above.

The variable light transmission device may comprise a first microcell and a second microcell, the first microcell comprising a first protrusion structure having a first protrusion base and 1, 2, 3, 4, 5, or 6 concavities, each concavity having a lower base, the combination of the first protrusion base and the lower bases of the concavities of the first microcell forming a first geometric shape, the first geometric shape having a first center. The second microcell may comprise a second protrusion structure having a second protrusion base and 1, 2, 3, 4, 5, or 6 concavities, each concavity having a lower base, the combination of the second protrusion base and the lower bases of the concavities of the second microcell forming a second geometric shape, the second geometric shape having a second center. The first protrusion base may have no C2 symmetry to the second protrusion base about a symmetry axis, the symmetry axis being vertical to the plane of the first protrusion base, the symmetry axis passing through a point that is the middle of the distance between the first centers and the second center. C2 symmetry of the first protrusion base to the second protrusion base means that rotation around the symmetry axis through an angle of 180° leaves the first and second protrusion bases indistinguishable from the first and second protrusion bases before the rotation. The variable light transmission device may comprise, in addition to the first and second microcells, a third microcell. The third microcell may comprise a third protrusion structure having a third protrusion base and 1, 2, 3, 4, 5, or 6 concavities, each concavity having a lower base, the combination of the third protrusion base and the lower bases of the concavities of the third microcell forming a third geometric shape, the third geometric shape having a third center. The third protrusion base may have no C2 symmetry to the first protrusion base about a symmetry axis, the symmetry axis being vertical to the plane of the first protrusion base, the symmetry axis passing through a point that is the middle of the distance between the first center and the third center. The third protrusion base may have no C2 symmetry to the second protrusion base about a symmetry axis, the symmetry axis being vertical to the plane of the second protrusion base, the symmetry axis passing through a point that is the middle of the distance between the second center and the third center.

The variable light transmission device of the present invention may comprise a microcell wherein the geometric solid of the protrusion volume may be a polygonal pyramid on a polygonal pyramid frustum. The polygonal pyramid has a first slope (θ1), and the pyramid frustum has a second slope (θ2). The second slope (θ2) may be larger than the first slope (θ1), and the difference between the second slope (θ2) and the first slope (θ1) may be from 1 to 25 degrees, from 1 to 30 degrees, from 2 to 20 degrees, from 2 to 15 degrees, from 2 to 12 degrees, from 2 to 9 degrees, from 2 to 8 degrees, from 3 to 8 degrees, or from 4 to 8 degrees. The geometric solid of the protrusion volume of the protrusion structure of a microcell may be a first polygonal pyramid frustum on a second polygonal pyramid frustum. The first polygonal pyramid frustum has a first slope (θ1), and the second pyramid frustum has a second slope (θ2). The second slope (θ2) may be larger than the first slope (θ1), and the difference between the second slope (θ2) and the first slope (θ1) may be from 1 to 25 degrees, from 1 to 30 degrees, from 2 to 20 degrees, from 2 to 15 degrees, from 2 to 12 degrees, from 2 to 9 degrees, from 2 to 8 degrees, from 3 to 8 degrees, or from 4 to 8 degrees. The geometric solid of the protrusion volume of the protrusion structure of a microcell may be a cone on a conical frustum, the cone having a first slope (θ1) and the conical frustum having a second slope (θ2). The second slope (θ2) may be larger than the first slope (θ1), and the difference between the second slope (θ2) and the first slope (θ1) may be from 1 to 25 degrees, from 1 to 30 degrees, from 2 to 20 degrees, from 2 to 15 degrees, from 2 to 12 degrees, from 2 to 9 degrees, from 2 to 8 degrees, from 3 to 8 degrees, or from 4 to 8 degrees. The geometric solid of the protrusion volume of the protrusion structure of a microcell may be a first conical frustum on a second conical frustum, the first conical frustum having a first slope (θ1) and the second conical frustum having a second slope (θ2). The second slope (θ2) may be larger than the first slope (θ1), and the difference between the second slope (θ2) and the first slope (θ1) may be from 1 to 25 degrees, from 1 to 30 degrees, from 2 to 20 degrees, from 2 to 15 degrees, from 2 to 12 degrees, from 2 to 9 degrees, from 2 to 8 degrees, from 3 to 8 degrees, or from 4 to 8 degrees.

The variable light transmission device of the present invention comprises a microcell having an inside wall surface and a microcell bottom surface. The inside wall surface and the microcell bottom surface form an angle (φ). The angle (φ) may be from 90 to 120 degrees, from 90 to 110 degrees, from 90 to 100 degrees, from 92 to 120 degrees, from 92 to 110 degrees, from 92 to 100 degrees, from 95 to 120 degrees, from 95 to 110 degrees, or from 95 to 110 degrees.

The variable light transmission device of the present invention may comprise a first adhesive layer, the first adhesive layer being disposed between the sealing layer and the first light transmissive electrode layer. The variable light transmission device of the present invention may comprise a second adhesive layer, the second adhesive layer being disposed between the microcell layer and the second light transmissive electrode layer. The variable light transmission device of the present invention may comprise a first adhesive layer and a second adhesive layer. The first adhesive layer is disposed between the sealing layer and the first light transmissive electrode layer, and the second adhesive layer is disposed between the microcell layer and the second light transmissive electrode layer.

The variable light transmission device of the present invention may comprise a light blocking layer disposed between the microcell upper surface and the sealing layer. The light blocking layer may comprise a light absorbing pigment. The light absorbing pigment of the light blocking layer may have black color. The light blocking layer may comprise a light reflecting pigment. The light absorbing pigment of the light blocking layer may have white color.

The electrophoretic medium comprises a charge control agent. The content of the charge control agent in the electrophoretic medium of the variable light transmission device may be from 0.1 weight percent to 8 weight percent of charge control agent by weight of the electrophoretic medium. The molecular structure of the charge control agent may include a quaternary ammonium functional group and a non-polar tail. The non-polar liquid of the electrophoretic medium may comprise a material selected from the group consisting of an aliphatic hydrocarbon, a cycloaliphatic hydrocarbon, an aromatic hydrocarbon, a halogenated aliphatic hydrocarbon, a polydimethylsiloxane, or mixture thereof.

### BRIEF DESCRIPTION OF DRAWINGS

FIG. 1 is an illustration of a cylindrical particle in a liquid under the influence of an applied electric field and resulting forces on the particle.

FIGS. 2A, 2B, 2C and 2D illustrate a side view of an example of a portion of a variable light transmission device of the present invention.

FIG. 3A illustrates a side view of a microcell in the open optical state of a variable light transmission device of the present invention; FIG. 3B illustrates a side view of the microcell in the closed optical state. The electrophoretic medium comprises one type of electrically charged pigment particles.

FIG. 4A is an example of a DC-imbalanced waveform that can be applied on a variable light transmittance device to achieve a closed state; the waveform includes an AC waveform having a duty cycle that is higher than 50%.

FIG. 4B is an example of DC-imbalanced waveform that can be applied on a variable light transmittance device to achieve a closed state; the waveform is a superposition of a DC voltage component and an AC waveform.

FIG. 5 illustrates the force exerted by an electrically charged pigment particle on the surface of a conical protrusion of the variable light transmission device of the present invention.

FIGS. 6B, 6D, 6F, and 6H show a comparison of Fraunhofer diffraction patterns formed by apertures of the following shapes, respectively: (a) triangular, shown in FIG. A, (b) square, shown in FIG. 6C, (c) pentagonal, shown in FIG. 6E, and (d) hexagonal, shown in FIG. 6G.

FIG. 7A shows a circular aperture. FIG. 7B shows a comparison of a Fraunhofer diffraction pattern formed by a circular aperture.

FIG. 8A shows a circular aperture having serrations. FIG. 8B shows a comparison of a Fraunhofer diffraction pattern formed by a circular aperture having serrations.

FIG. 9 illustrates a microcell base of a microcell of a variable light transmission device of the present invention, the microcell having an hexagonal shape and a conical protrusion structure, the protrusion structure having one concavity.

FIG. 10 illustrates the lower base of the concavity of the protrusion structure of the microcell of the variable light transmission device of the present invention shown in FIG. 9; the concavity has a depth 222d and a width 222w.

FIG. 11 illustrates a microcell base of a microcell of a variable light transmission device of the present invention, the microcell having an hexagonal shape and a conical protrusion structure, the protrusion structure having two concavities.

FIG. 12 illustrates a microcell base of a microcell of a variable light transmission device of the present invention, the microcell having an hexagonal shape and a conical protrusion structure, the protrusion structure having three concavities.

FIG. 13 is a top view of the microcell shown in FIG. 12, wherein the microcell channel (215) is illustrated; the channel has an inner base perimeter (224), an outer base perimeter (225), and a channel width 216w.

FIG. 14 is a side view of a microcell of a variable light transmission device of the present invention, the microcell comprising a protrusion structure (217) with a concavity (222), the concavity having a concavity height (222h).

FIG. 15 is a side view of a microcell of a variable light transmission device of the present invention, the microcell comprising a protrusion structure (217) with a concavity (222), the concavity having a concavity height (222h), the microcell also comprising a having a light blocking layer (230).

FIG. 16 is a side view of a microcell of a variable light transmission device of the present invention, the microcell comprising a protrusion structure (217) microcell walls (212), microcell walls having an inside wall surface 213, and a microcell bottom surface (211); the inside wall surface (213) and the microcell bottom surface (211) form an angle (ϕ), the angle (ϕ) being larger than 90 degrees.

FIG. 17 is a side view of a microcell of a variable light transmission device of the present invention, the microcell comprising a protrusion structure (217), the protrusion structure being a cone on a conical frustum, the slope of the conical frustum θ2 being larger than the slope of the cone θ1.

FIG. 18 is a side view of a microcell of a variable light transmission device of the present invention, the microcell comprising a protrusion structure (217), the protrusion structure being a cone on a conical frustum, the slope of the conical frustum θ2 being larger than the slope of the cone θ1; in this microcell the inside wall surface (213) and the microcell bottom surface (211) form an angle (ϕ), the angle (ϕ) being larger than 90 degrees.

FIG. 19A illustrates a top view of a variable light transmission device according to the present invention, the device comprising a plurality of microcells, each of the plurality of microcells having a protrusion structure with three concavities.

FIG. 19B shows a Fraunhofer diffraction pattern formed by the variable light transmission device illustrated in FIG. 19A.

FIG. 20A illustrates a variable light transmission device having a plurality of microcells, each of the plurality of microcells having a cone protrusion structure and a channel with circular inner and outer base perimeters.

FIG. 20B shows a Fraunhofer diffraction pattern formed by the variable light transmission device illustrated in FIG. 20A.

FIG. 21A illustrates a variable light transmission device having a plurality of microcells, each of the plurality of microcells having hexagonal inner and outer base perimeters.

FIG. 21B shows a Fraunhofer diffraction pattern formed by the variable light transmission device illustrated in FIG. 21A.

### DETAILED DESCRIPTION OF THE INVENTION

As used herein, a “variable light transmission device” is a device comprising an electrophoretic medium, wherein the quantity of transmitted light through the device can be controlled by application of electric field across the electrophoretic medium.

“First outside surface of a variable light transmission device” and “second outside surface of a variable light transmission device” are the outside surface of the device that are parallel to the first light transmissive electrode layer and the second light transmissive electrode layer, respectively. The term “outside surface” as used herein, only refers to the main surfaces on the viewing sides of the variable light transmission device, not the smaller surface on the periphery of the device.

“A location of a variable light transmission device” is a point at the first outside surface or at the second outside surface of the device.

“Percent transparency of a variable light transmission device” (% T) at a location of the device is given by Equation 1. Thus, “percent transparency of a variable light transmission device” (% T) at a location of the device is the ratio of the intensity of light that is transmitted through the variable light transmission device and exiting from a location of the second outside surface of the variable light transmission device (I) to the intensity of light that enters the variable light transmission device from a location at the first outside surface of the variable light transmission device (Io) times 100; the location of the second outside surface is symmetrical to the location of the first outside surface with respect to a plane, the plane being at equal distance between the first light transmissive electrode layer and the second light transmissive electrode layer.

$$\% T = ( I / Io ) \times 100 \qquad ( Equation 1 )$$

Analogously, “transparency, or transmission, of a variable light transmission device” at a location of the device is the ratio of the intensity of light that is transmitted through the variable light transmission device and exiting from a location of the second outside surface of the variable light transmission device (I) to the intensity of light that enters the variable light transmission device from a location at the first outside surface of the variable light transmission device (Io).

“Optical Density” of a variable light transmission device” (OD) at a location of the device is given by Equation 2. Thus, “optical density percent of a variable light transmission device” (OD) at a location of the device is the logarithm of the ratio of the intensity of light that enters the device at a location at the first outside surface of the variable light transmission device (Io) to the intensity of light that is transmitted through the variable light transmission device and exiting from a location of the second outside surface of the variable light transmission device (I); the location of the second outside surface is symmetrical to the location of the first outside surface with respect to a plane, the plane being at equal distance between the first light transmissive electrode layer and the second light transmissive electrode layer.

$$OD = log ( Io / I ) \qquad ( Equation 2 )$$

“A location of a device being adjacent to a channel” means that, if a line is drawn from the location vertically to an outer surface of the device, the line will cross the channel of the microcell.

The distance of a point from a plane is the shortest perpendicular distance from the point to the plane. The shortest distance from a point to a plane is the length of the perpendicular parallel to the normal vector dropped from the given point to the given plane.

The distance between two planes in a three-dimensional space is the shortest distance between the planes. It is the shortest distance between any point on one plane and any point on the other plane.

“Average particle size of a type of particles” is the average length of the largest dimension of the particles.

“A frustum” is the base portion of a cone or a polygonal pyramid obtained by cutting the apex portion with a plane parallel to the base. It is also called a flat-top cone or pyramid because it does not have an apex but has two parallel bases.

Slope of a cone is defined as the angle that has (a) vertex (A) on the circumference of the base of the cone, (b) first arm the line that connects point A (vertex) and the center of the base of the cone C, and (c) second arm the line that connects point A (vertex) and the apex of the cone.

Slope of a conical frustum is defined as the angle that has (a) vertex (A) on the circumference of the bottom (large) base of the cone, (b) first arm is the line that connects point A (vertex) and the center of the bottom base of the conical frustum C, and (c) second arm the line that is the intersection of the lateral surface of the conical frustum and a plane that includes the linear segment AC, the plane being vertical to the bottom base of the conical frustum.

Slope of a polygonal pyramid is defined as the angle that has (a) vertex (A) on a point of the perimeter of the base of the polygonal pyramid, (b) first arm the line that connects point A (vertex) and the center of the base of the polygonal pyramid C, and (c) second arm the line that connects point A (vertex) and the apex of the cone. Slope of a polygonal pyramid frustum is defined as the angle that has (a) vertex (A) on a point of the perimeter of the bottom (large) base of the polygonal pyramid, (b) first arm the line that connects point A (vertex) and the center of the bottom base of the polygonal pyramid frustum C, and (c) second arm the line that is the intersection of the lateral surface of the polygonal pyramid frustum and a plane that includes the linear segment AC, the plane being vertical to the bottom base of the polygonal pyramid frustum.

The term “electrically charged pigment particles” refers to electrically charged pigment particles that may or may not have a polymeric material on the surface of the pigment particles.

The term “protrusion volume” refers to the volume of the protrusion structure and includes the volumes of all concavities of the one or more concavities. To clarify the term “protrusion volume” we can consider that the protrusion structure is a combination of a solid part of the protrusion structure and one or more concavities. The protrusion volume consists of the volume of the solid part of the protrusion and the volumes of all of the one or more concavities. The protrusion volume is a geometric solid.

The term “total protrusion surface” refers to the total surface of the protrusion structure without including the one or more concavities in the protrusion structure. That is, the total protrusion surface consist of the surface of the protrusion base and the surface of the protrusion structure that is in contact with the electrophoretic medium. The term “exposed protrusion surface” is the total protrusion surface not including the surface of the protrusion base and not including any part of the surface of the protrusion apex. If the protrusion apex is a point, the surface of the protrusion apex is zero. If the protrusion apex is a set of points, the set of points have a surface that is higher than zero.

A “microcell inside wall surface” is the surface of the microcell wall that is in contact with the electrophoretic medium of the microcell.

A “microcell wall upper surface” is the surface of the microcell wall that is in contact with the sealing layer of the microcell. In the case that there is a light blocking layer on the microcell wall upper surface, the light blocking layer is disposed between the microcell wall upper surface and the scaling layer.

The term “channel width” is defined as the smallest distance between the inner base perimeter and outer base perimeter of a channel.

The term “DC-balanced waveform” or “DC-balanced driving waveform” applied to a pixel is a driving waveform where the driving voltage applied to the pixel is substantially zero when integrated over the period of the application of the entire waveform. The DC balance can be achieved by having each stage of the waveform balanced, that is, a first positive voltage will be chosen such that integrating over the subsequent negative voltage results in zero or substantially zero. If the waveform is not DC-balanced, it is referred to as “DC-imbalanced waveform” or “DC-imbalanced driving waveform.” The driving waveform applied to a pixel may have a DC-imbalanced portion and at least one additional pulse of the opposite impulse to ensure that the overall waveform applied to a pixel is DC-balanced. This additional pulse may be applied before the DC-imbalanced portion of the waveform (pre-pulse). Typical examples of DC-imbalanced waveforms include (a) a square or sinusoidal AC waveform having a duty cycle of less (or more) than 50%, and (b) square or sinusoidal AC waveform that has a DC offset.

The term “impulse” is the integral of voltage with respect to time. That is, for a waveform pulse having a voltage V applied for time t, the impulse is V×t. The impulse can be positive, if the polarity of voltage V is positive, or negative, if the polarity of voltage V is negative.

The term “net positive impulse” of a waveform means that negatively electrically charged pigment particles will be attracted to and will move towards the first light transmissive electrode layer during the application of the waveform.

The term “lateral component of velocity” in relation to the movement of electrically charged pigment particles in a microcell of the variable light transmission device of the present invention is the velocity in the horizontal direction. For this definition, we assume that the velocity of the electrically charged particles is a vector resulting from the vector addition of the velocity in the horizontal direction (Vh), and the velocity in the vertical direction (Vv), and that the vertical direction in the case of the movement of the electrically charged pigment particles inside an electrophoretic microcell is the direction from the first light transmissive electrode layer to the second light transmissive electrode layer or form the second light transmissive electrode layer to the first light transmissive electrode layer. In the same system, the horizontal direction of the movement of the electrically charged pigment particles inside an electrophoretic microcell is the direction from one side of the microcell wall to the other side of the microcell wall, this direction being parallel to the first light transmissive electrode layer. Thus, the statement “the velocity of the electrically charged pigment particles has a lateral component” means that the magnitude of the velocity in the horizontal direction is larger than zero.

“Vertical plane” of a channel of a microcell is defined herein as a plane that is vertical to the plane of the exposed microcell bottom inside surface and containing points A and B, wherein point A is a point on an outside base perimeter of a channel of a microcell, point B is a point on an inside perimeter of the channel of the same microcell, A and B being part of a line segment that corresponds to the minimum distance between the outer base perimeter and the inner base perimeter of the channel.

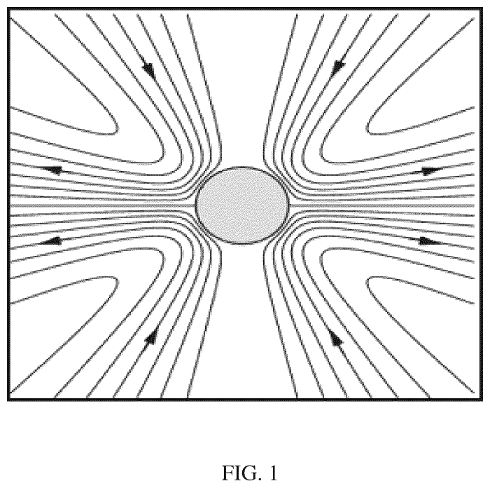

The phenomenon of Induced-Charge-Electro-Osmosis (ICEO) can be utilized to move polarizable particles, such as pigment particles, which are present in an electrophoretic medium, laterally. That is, the polarizable particles can move parallel to the electrode layers that sandwich the electrophoretic medium. In the presence of an electric field, a particle may experience a force, which is caused by polarization of the particle (or by polarization of an adsorbed conductive coating on the particle surface, or of the electrical double layer around the particle). This force may result in a perturbation in the flow of mobile charge, such as ions or charged micelles, in the electrophoretic medium, as shown in FIG. 1 for a cylindrical particle 101 surrounded by the liquid of the electrophoretic medium in the applied electric field. This figure is reproduced by the article of Bazant and Squires, J. Fluid Mech., 2004, 509, 217-252.

A perfectly symmetrical, spherical particle would experience no net force, but less symmetrical particles would experience forces having a component perpendicular to the direction of the applied field. The cooperative flows, which are created by a swarm of particles each experiencing such forces, can lead to “swirling” of an electrophoretic medium containing multiple particles. The maximum velocity u of this swirling for a particular particle, according to the theory advanced in the article by Bazant and Squires, would be given approximately by Expression 1.

$$u ∝ \frac{ε {RE}^{2}}{η ( 1 + {ω}^{2} {τ}^{2} )} \qquad ( Expression 1 )$$

In Expression 1, E is the field strength, ε is the dielectric constant of the solvent, η is the viscosity of the electrophoretic fluid, ω is the applied sinusoidal AC frequency, and τ is the time scale for building up a screening charge layer by motion of solvent-borne charges around charge. The time scale τ is given by Equation 3.

$$ τ = \frac{{λ}_{D} R}{D} \qquad ( Equation 3 )$$

In Equation 3, λ_{D} is the Debye screening length, R is the particle radius, and D is the diffusion constant of charge carriers in the fluid.

According to Expression 1, as the frequency is raised, the value of ω²τ² increases, and the maximum velocity of induced-charge flows decreases. Furthermore, for values of ω²τ² that are significantly larger than 1, the maximum swirling velocity is proportional to the square of the ratio E/ω. Induced-charge flows occur in the same direction regardless of the polarity of the applied electric field and can thus be driven by alternating fields.

When the electrophoretic medium is contained within a microcell, as is preferred in electrophoretic displays, the geometries of the induced flows are affected by the shape of the particular microcell used. For example, in the simplest case of two parallel electrodes, it was shown that, using an appropriate electric field strength and AC frequency, the flow can adopt a roll structure with periodic spacing that corresponds to the width of the gap between the electrodes.

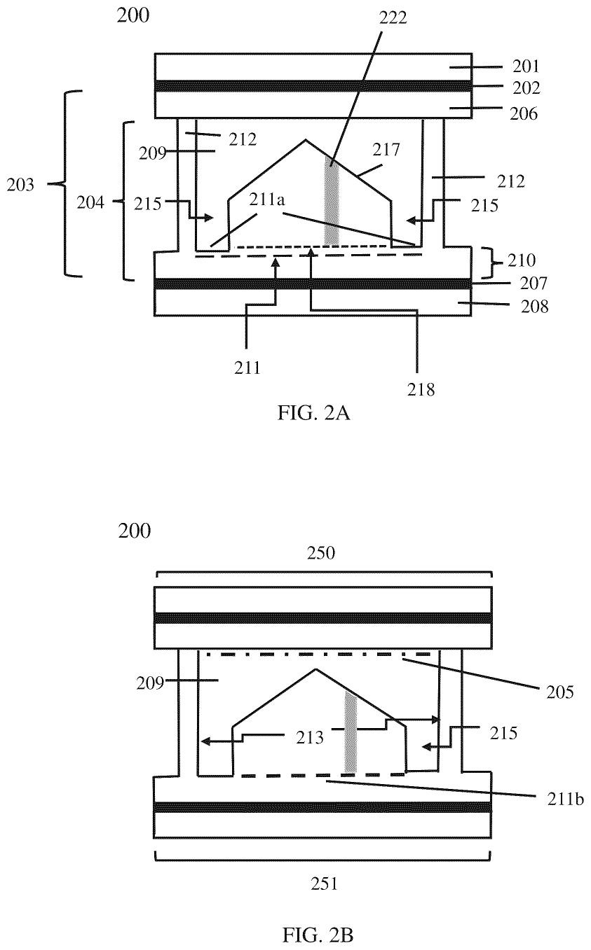

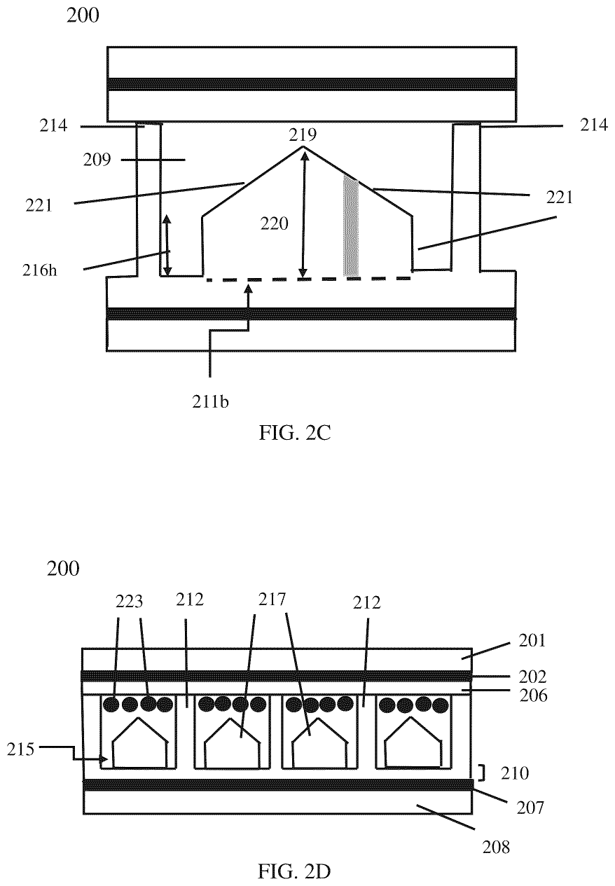

The inventors of the present invention used complex microcell structures that may be formed by an embossing method to make variable light transmission devices. In one example, the embossed structure includes a protrusion structure on the bottom of each microcell. FIGS. 2A, 2B, and 2C illustrate a side view of a microcell of a variable light transmission device according to the present invention wherein the protrusion structure of the variable light transmission device is a cone on a cylinder. The protrusion structure comprises one or more concavities (222). In the example of FIGS. 2A, 2B, and 2C, there is one concavity in the protrusion structure. The concavity 222 of the protrusion structure 217 includes electrophoretic medium. The protrusion structure can direct the electrophoretic flow of particles into a channel, as shown in FIGS. 2A, 2B, 2C. The electrically charged pigment particles would move towards the channel, if the electric field applied across the electrophoretic medium has the appropriate polarity in relation to the polarity of the electrically charged pigment particles. For example, the electrically charged pigment particles will move towards the channel, if the electrically charged pigment particles are positively charged and the applied voltage via the light transmissive electrodes results in negative polarity on the second light transmissive electrode. The same movement will take place if the electrically charged pigment particles are negatively charged and the applied voltage via the light transmissive electrodes results in positive polarity on the second light transmissive electrode. FIGS. 2A, 2B, and 2C illustrate a cross-section (not to scale) of a portion of a variable light transmission device that shows only one microcell of the plurality of microcells of the device. All three FIGS. 2A, 2B, and 2C are identical in terms of the device structure that is illustrated, but different parts of the device are identified on each of the figures.

The microcell of the variable light transmission device 200 illustrated in FIGS. 2A, 2B, and 2C comprises a microcell layer comprising a plurality of microcells 204 and a sealing layer 206. Although only one microcell is represented in FIGS. 2A, 2B, and 2C, one can envision the whole variable light transmission device that comprises the microcell layer 203 comprising a plurality of microcells 204. The variable light transmission device 200 may comprise first light transmissive substrate 201, first light transmissive electrode layer 202, a microcell layer 203 comprising a plurality or microcells 204 and a sealing layer 206, second light transmissive electrode layer 207, and second light transmissive substrate 208. Each microcell of the plurality of microcells 204 comprises an electrophoretic medium 209 including electrically charged pigment particles, a charge control agent, and a non-polar liquid. The components of the electrophoretic medium 209 (electrically charged pigment particles, charge control agent, non-polar liquid) are not shown in FIGS. 2A, 2B, and 2C. Each microcell of the plurality of microcells 204 has a microcell opening 205, the sealing layer 206 spanning the microcell openings 205 of the plurality of microcells 204. Each microcell of the plurality of microcells 204 comprises microcell bottom layer 210, protrusion structure 217, microcell walls 212, and channel 215. Microcell bottom layer 210 has microcell bottom inside surface 211. The microcell bottom inside surface 211 comprises exposed microcell bottom inside surface 211a and unexposed microcell bottom inside surface 211b. Unexposed microcell bottom surface 211b is in contact with the protrusion base 218.

In this example of a microcell, the protrusion structure 217 is a cone on a cylinder and also comprises one protrusion structure 222, the protrusion structure including electrophoretic medium 209. Protrusion structure 217 has a protrusion base, an exposed protrusion surface 221, a protrusion apex 219, a protrusion height 220, and one concavity (222). In general, a microcell of the plurality of microcells of the variable light transmission device of the present invention may have a protrusion structure comprising one or more concavities. The plurality of microcells of the variable light transmission device of the present invention may have a protrusion structure with not more than six concavitites in each protrusion structure. In the example of FIGS. 2A-2C, the protrusion volume of the protrusion structure is a geometric solid, the geometric solid being a cone on a cylinder. The protrusion apex 219 is a point (or a set of points) of the protrusion structure 217 having shorter distance from microcell opening 205 than all other points of the protrusion structure 217. In the example of the variable light transmission device of FIGS. 2A, 2B, and 2C, the protrusion apex 219 is a point. The protrusion apex is the apex of the cone. The protrusion height 220 is the distance between the protrusion base 218 and the protrusion apex 219. If the protrusion structure 217 has a protrusion apex 219 that comprises more than one point, the protrusion apex is a planar surface. In this case, the protrusion height 220 is the distance between the planar surface of the protrusion apex and the protrusion base 218 of the protrusion structure 217. A microcell layer comprising a plurality of microcells 204 having protrusion structure 217 may be manufactured by embossing thermoplastic or thermoset precursor layer using a pre-patterned male mold, followed by releasing the mold. The precursor layer may be hardened by radiation, cooling, solvent evaporation, or other means during or after the embossing step.

Microcell walls 212 have microcell inside wall surface 213 and a microcell wall upper surface 214. The microcell inside wall surface 213 is in contact with electrophoretic medium 209. The microcell wall upper surface 214 is the surface of microcell walls 212 of a microcell that is in contact with sealing layer 206. Furthermore, FIG. 2B shows first outside surface 250 being located on a side of the variable light transmission device that is near the first light transmissive electrode layer (202), and second outside surface (251) being located on a side of the variable light transmission device that is near the second light transmissive electrode layer (207).

Channel 215 is defined as the volume between exposed microcell bottom inside surface 211a, microcell inside wall surface 213, and exposed protrusion surface 221, the microcell inside wall surface (213) and a plane that is parallel to the microcell bottom inside surface (211), the plane having a distance from the microcell bottom inside surface (211) equal to the channel height (216h). This definition shows that a portion of the volume of the concavity is also part of the channel. Channel height 216h is 50% of the protrusion height 220. Channel width is the smallest distance between the inner base perimeter and outer base perimeter of a channel.

FIG. 2D illustrates a side view of a portion of an example of a variable light transmission device according to the present invention wherein the protrusion volume is a cone on a cylinder. The concavity or concavities of the protrusion structure is not shown in FIG. 2D. The variable light transmission device illustrated in FIG. 2D is similar to that illustrated by FIGS. 2A, 2B, 2C, but shows a larger portion of the device that includes four microcells. Variable light transmission device 200 comprises first light transmissive substrate 201, first light-transmissive electrode layer 202, a microcell layer 203 comprising a plurality or microcells 204 and a scaling layer 206, second light transmissive electrode layer 207, and second light transmissive substrate 208. Each microcell of the plurality of microcells comprises an electrophoretic medium including electrically charged pigment particles 223, a charge control agent, and a non-polar liquid. Each microcell of the plurality of microcells 204 has a microcell opening, the scaling layer 206 spanning the microcell openings of the plurality of microcells. Each microcell of the plurality of microcells comprises microcell bottom layer 210, protrusion structure 217, microcell walls 212, and channel 215. The variable light transmission device illustrated in FIG. 2D is in the closed optical state.

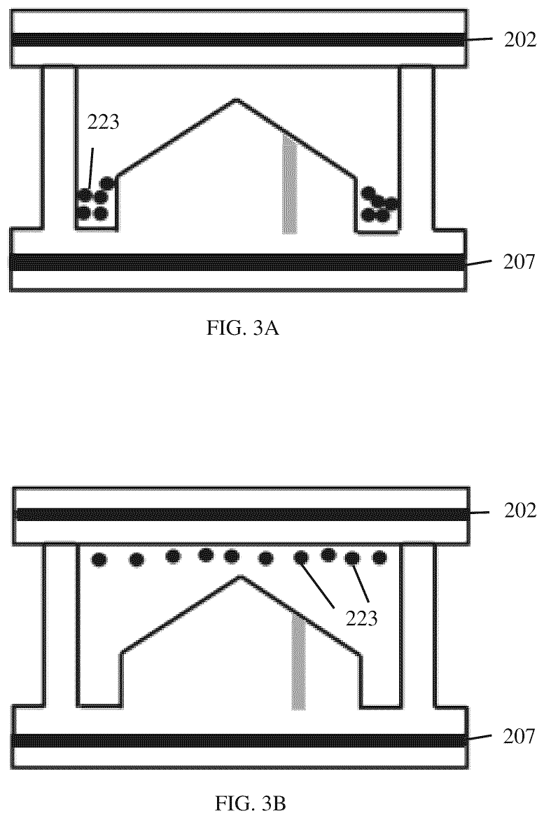

When a first electric field is applied between the first light transmissive electrode layer 202 and the second light transmissive electrode layer 207 via a first waveform, movement of the electrically charged pigment particles 223 towards the channel is caused when the polarity of the electrically charged pigment particles 223 and the voltage polarity of the second light transmissive electrode layer are opposite to each other. If the polarity of the electrically charged pigment particles 223 and the voltage polarity of the second light transmissive electrode layer are opposite to each other, the electrically charged pigment particles 223 will be attracted by the second light transmissive electrode, and the variable light transmission device will switch to an open optical state, the open optical state having higher percent transparency than the closed optical state. The open optical state is illustrated in FIG. 3A, where electrically charged pigment particles 223 are represented by black filled circles. In this example, the electrophoretic medium comprises one type of electrically charged pigment particles 223. In the open optical state, the electrically charged pigment particles 223 are present in the channel of the microcell. Thus, in the open optical state, light passing through the variable light transmission device from a location adjacent to the channel will be obstructed and the variable light transmission device will appear opaque adjacent to the channel, whereas the variable light transmission device will be light transmissive at other locations.

Application of a second electric field between the first light transmissive electrode layer 202 and the second light transmissive electrode layer 207 via a second waveform causes a movement of the electrically charged pigment particles 223 towards the first light transmissive electrode layer 202 with a velocity. This leads to the closed optical state, which is shown in FIG. 3B. The velocity has a lateral component. In the absence of a lateral component of the velocity, the closed optical state will not take place, because the electrically charged pigment particles 223 will move from the channel of the open state towards the first light transmissive electrode layer 202, but these electrically charged pigment particles 223 will occupy an area near the perimeter of a microcell at the vicinity of the sealing layer 206. That is, electrically charged pigment particles 223 will not be spread all across the surface of the first light transmissive electrode layer 202. Thus, the closed optical state will not be effectively formed, because the closed optical state will have relatively high light transmittance.

The above indicates that it is somewhat easier to achieve a transition from the closed optical state to the open optical state, because the slope of the protrusion structure, for example the cone of FIGS. 3A and 3B, will impart a lateral component to the velocity of the electrically charged pigment particles when they strike the exposed protrusion surface of the protrusion structure during their movement towards second light transmissive electrode layer.

It is possible to shape the electric field within the variable light transmission device by making the electrical conductivities of the electrophoretic medium and the cone substantially different from each other. For example, if the cone is much less conductive than the electrophoretic medium, the field lines will tend to direct the electrically charged pigment particles into the channel. However, even in such a case it may still be necessary to provide a more substantial horizontal force component to redisperse the electrically charged pigment particles from the channel into the entire microcell volume. In addition, it may be easier to assemble and operate the device when the resistivities of the cone material and the electrophoretic medium are about equal, each being about 10¹⁰ Ω*cm, in which case the electric field lines will be oriented approximately vertically through the microcell. Thus, it would be preferred to use a waveform in which lateral motion is imparted to the electrically charged pigment particles.

The variable light transmission device may be switched to an open optical state by applying a first electric field between the first light transmissive electrode layer and the second light transmissive electrode layer via a first waveform to cause movement of the electrically charged pigment particles towards the channel, resulting in the switching of the variable light transmission device to an open optical state. The electrically charged pigment particles in the open optical state are located inside the channel. The variable light transmission device may be switched to an open optical state by applying a second electric field between the first light transmissive electrode layer and the second light transmissive electrode layer via a second waveform to cause a movement of the electrically charged pigment particles towards the first light transmissive electrode layer with a velocity, the velocity having a lateral component, and leading to a closed optical state, the second waveform comprising a series of at least two positive and negative pulses having a net positive or net negative impulse, wherein the closed optical state has lower percent transparency than the open optical state. The electrically charged pigment particles may be light absorbing particles or light reflecting particles. The electrophoretic medium may comprise two types of electrically charged pigment particles, a first type and a second type. The first type of electrically charged pigment particles may be light absorbing, and the second type of electrically charged pigment particles may be light reflecting. The first type of electrically charged pigment particles may be black. The second type of electrically charged pigment particles may be white. The first and second types of electrically charged pigment particles may have the same charge polarity. The first and second types of electrically charged pigment particles may have the same charge polarity, but different magnitude of charges. The first and second types of electrically charged pigment particles may have a positive charge. An electrically charged pigment particle of the first type may have larger positive charge than that of an electrically charged pigment particle of the second type. The first and second types of electrically charged pigment particles may have a negative charge. An electrically charged pigment particle of the first type may have more negative charge than that of an electrically charged pigment particle of the second type.

The second waveform may be DC-imbalanced. The second waveform may comprise at least one positive voltage and at least one negative voltage, the second waveform having a net positive or a net negative impulse. The choice of a net positive or net negative impulse depends on the polarity of the electrically charged pigment particles to be moved to the location of the electrophoretic medium near the sealing layer. Specifically, if the closed state involves movement of the electrically charged pigment particles that are negatively charged, a net positive impulse is required to move those particles from the channel towards the first light transmissive electrode layer. In other words, this movement requires that the net result of the applied voltage be an attraction of the negatively charged particles by a positive voltage of the first light transmissive electrode layer in relation to the second light transmissive electrode layer. On the contrary, if the closed state involves movement of the electrically charged pigment particles that are positively, a net negative impulse is required to move the electrically charged pigment particles from the channel near the second light transmissive electrode layer 207 towards the first light transmissive electrode layer.

A second electric field that is applied between the two light transmissive electrode layers via a second waveform achieves a closed optical state.

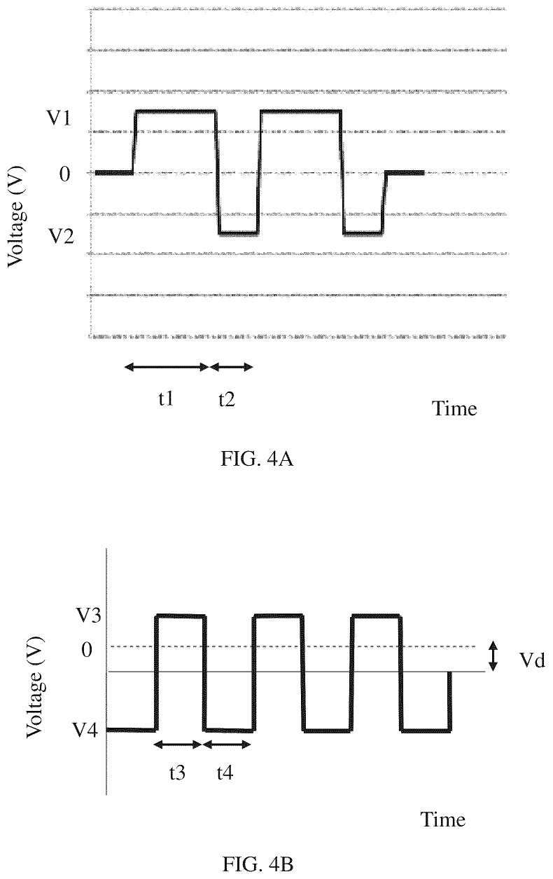

The second waveform may comprise an AC waveform, having a duty cycle different from 50%. An example of the second waveform is illustrated in FIG. 4A.

The AC waveform may have a positive or negative DC bias. DC bias may be achieved by controlling the duty cycle of the waveform. The duty cycle for a positively DC biased waveform is higher than 50%. The duty cycle of a positively DC biased waveform may be higher than 55%, higher than 60%, or higher than 65%. The duty cycle for a positively DC biased waveform may be from 55% to 95%, from 58% to 90%, from 60% to 88%, from 65% to 85%, or from 70% to 80%. Analogously, the duty cycle for a negatively DC biased waveform is lower than 50%. The duty cycle for a negatively DC biased waveform may be lower than 45%, lower than 40%, or lower than 35%. The duty cycle for a negatively DC biased waveform may be from 5% to 45%, from 8% to 40%, from 10% to 38%, from 15% to 35%, or from 20% to 30%.

The waveform illustrated in the example of FIG. 4A comprises an AC square waveform having two or more cycles. Each cycle may comprise a first pulse of amplitude V1 applied for time period t1 and a second pulse of amplitude V2 applied for time period t2, wherein V1 is positive and V2 is negative, and wherein t1 is larger than t2. In the case that the amplitude of V1 is equal to the amplitude of V2 (|V1|=|V2|), a DC bias is achieved by the difference in the time periods. In the case of the example of FIG. 4A, there is a positive DC bias, because the positive voltage V1 is applied for a longer time period (t1) than that of the negative voltage V2 (t2). Positive DC bias means that, if the electrically charged pigment particles of the variable light transmission device are negatively charged, the electrically charged pigment particles will move towards the first light transmissive electrode layer of the device. The duty cycle of the waveform can be calculated by Equation 4.

Duty Cycle=100×(V1·t1)/[(V1·t2)+(V2·t2)] Equation 4

In the waveform example of FIG. 4A, the amplitude of V1 can be equal to the amplitude V2 (|V1|=|V2|), but, in general, the amplitudes V1 and V2 may be different from each other.

The example of the driving waveform of FIG. 4A is DC-imbalanced. However, one or more additional pulses may be included in the waveform of FIG. 4A of the opposite impulse, which can ensure that the overall waveform applied on a pixel is DC-balanced. This additional pulse (or additional pulses) may be applied before the DC-imbalanced waveform (pre-pulse). Also, the example of the waveform of FIG. 4A is a square AC waveform. Other examples of AC waveforms that can be used include sinusoidal waveforms, trigonal waveforms, and sawtooth waveforms.

The AC waveform may have an amplitude of from 10V to 200V and a frequency of from 0.1 to 6000 Hz. The AC waveform may have an amplitude of from 15V to 180V, from 20V to 160V, from 25V to 150V, or from 30V to 140V. The AC waveform may have a frequency of from 0.5 Hz to 5000 Hz, from 1 Hz to 4000 Hz, from 5 Hz to 3000 Hz, from 10 Hz to 2000 Hz, from 15 Hz to 1000 Hz, from 20 Hz to 800 Hz, or from 25 to 600 Hz. The ratio of the frequency of the AC waveform to the weight percent content of the charge control agent by weight of the electrophoretic medium may be from 400 Hz to 2000 Hz.

The second waveform may comprise a waveform that is formed by a superposition of a DC voltage component and an AC waveform. An example of the second waveform is illustrated in FIG. 4B.

The waveform of FIG. 4B has a net negative impulse because of a DC offset (Vd). Although the period of time (t3) of the application of positive pulse is equal to the period of time (t4) of the application of negative pulse, a DC bias is achieved by the difference in the amplitudes of the pulses. Specifically, amplitude V3 of the positive pulse is smaller than amplitude V4 of the negative pulse. This is caused by the DC voltage component Vd of the waveform. That is, the waveform illustrated in FIG. 4B has a DC offset.

The example of the driving waveform of FIG. 4B is DC-imbalanced. However, one or more additional pulses may be included in the waveform of FIG. 4B of the opposite impulse, which can ensure that the overall waveform applied on a pixel is DC-balanced. This additional pulse (or additional pulses) may be applied before the DC-imbalanced waveform (pre-pulse). Also, the example of the waveform of FIG. 4B is a square AC waveform. Other examples of AC waveforms that may be used include a sinusoidal waveform, a trigonal waveform, and a sawtooth waveform.

The AC waveform may have an amplitude of from 10V to 200V and a frequency of from 0.1 to 6000 Hz. The AC waveform may have an amplitude of from 15V to 180V, from 20V to 160V, from 25V to 150V, or from 30V to 140V. The AC waveform may have a frequency of from 0.5 Hz to 5000 Hz, from 1 Hz to 4000 Hz, from 5 Hz to 3000 Hz, from 10 Hz to 2000 Hz, from 15 Hz to 1000 Hz, from 20 Hz to 800 Hz, or from 25 to 600 Hz. The ratio of the frequency of the AC waveform to the weight percent content of the charge control agent by weight of the electrophoretic medium may be from 400 Hz to 2000 Hz.

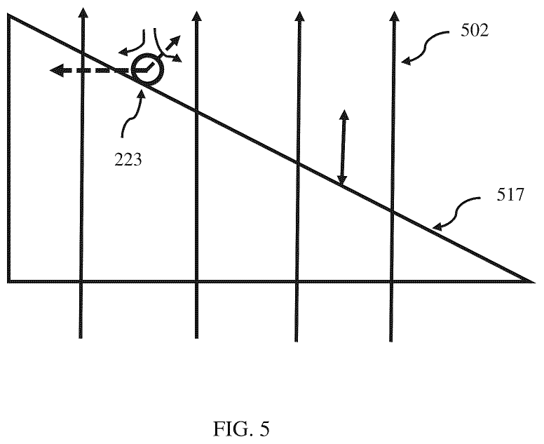

In a case where the ICEO-induced motion of the electrically charged pigment particles is relatively low, the protrusion structure of the microcell contributes to an effective operation of the variable light transmission device, even if the device is driven using a DC-balanced AC waveform. In the example of the protrusion structure being a cone, any electrically charged pigment particles that are located at the surface of the cone will experience a net force that will move them towards the apex of the cone, as shown in FIG. 5. FIG. 5 shows electrically charged pigment particle 223 in contact with protrusion structure 517 (conc) in an electric field 502. In this case, the ICEO flows are illustrated by the curved arrows, being more constrained on the “uphill” side of the cone than the “downhill” side. This imparts a force to the particle shown by the dotted horizontal arrow. There will be an opposing force perpendicular to the cone, forcing the particle towards the apex of the conc. With an appropriate choice of AC fields and frequencies, the particles can be moved out of the channel region and up the sides of the cone in this way.

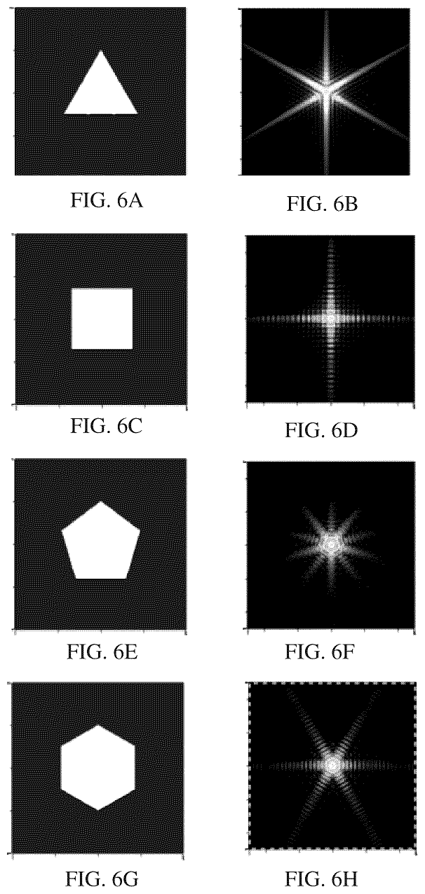

One problem encountered in open optical states of variable light transmission devices, where light-absorbing electrically charged pigment particles are located in the channels of microcells, is diffraction patterns that are observable within the field of vision. Such diffraction patterns, known as Fraunhofer diffraction patterns, can be disturbing to a viewer and are formed when light from a small object such as a light source in a dark ambient environment or when light from specular reflections of the sun in a bright ambient environment passes through the variable light transmission device in the open optical state. The cause the diffraction patterns is the existence of straight edges with sharp transition from light absorbing to light transmitting areas in the channels of microcells. Such straight edges are formed by the arrangement of the absorbing particles in the channels of microcells. It is well known that the resulting diffraction pattern is directly related to the light transmissive shape of the microcell in the open state (aperture). The images of FIGS. 6B, 6D, 6F, and 6H show various Fraunhofer diffraction patterns, which are formed by various aperture shapes, the aperture shapes being shown in FIGS. 6A, 6C, 6E, and 6G respectively. Specifically, a triangle aperture forms the diffraction pattern shown in FIG. 6A, a square aperture forms the diffraction pattern shown in FIG. 6C, a pentagon aperture forms the diffraction pattern shown in FIG. 6E, and a hexagon aperture forms the diffraction pattern shown in FIG. 6G. In all these examples, the resulting diffraction patterns include highly visible linear components. Thus, there are six linear components in the diffraction pattern shown in FIG. 6B, four linear components in the diffraction pattern shown in FIG. 6D, ten linear components in the diffraction pattern shown in FIG. 6F, and six linear components in the diffraction pattern shown in FIG. 6H.

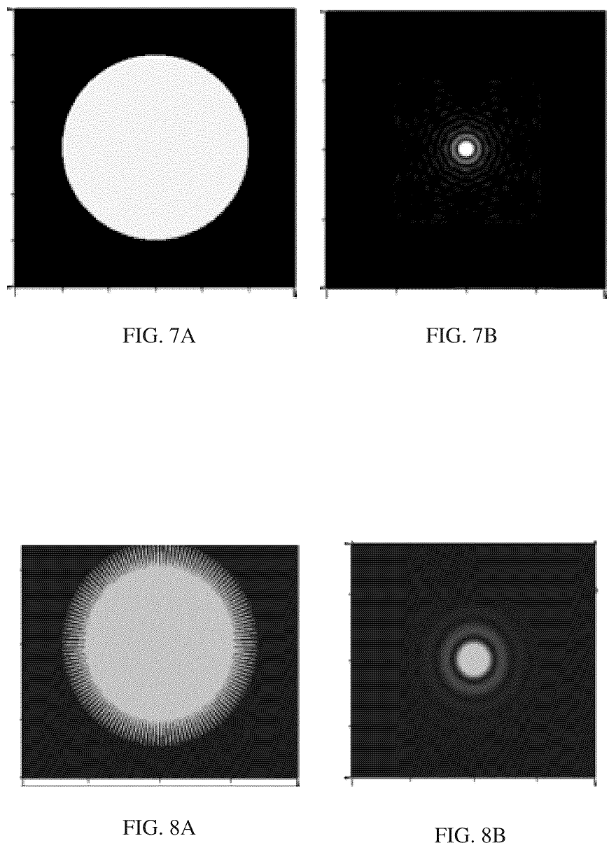

There are several ways of mitigating diffraction patterns having highly visible linear features. Firstly, the use of a circular aperture, which is shown in FIG. 7A, forms a diffraction pattern where the intensity of diffraction is uniformly distributed over all diffraction angles. Thus, in the case of circular aperture, the highly visible linear diffraction patterns, shown in FIGS. 6B, 6D, 6F, and 6H, are transformed into less visible diffraction rings of lower intensity, as shown in FIG. 7B. FIG. 7B shows a diffraction pattern that includes concentric rings with decreasing light intensity as the diameter of the ring increases. Secondly, it was previously suggested (U.S. Patent Application with Publication No. 2023/0100320A1) to use apodization to mitigate highly visible linear diffraction patterns by softening the sharp transition from light absorbing to light transmitting area by replacing the straight edges of hexagonal and circular apertures with irregular or regular shapes. Regular shapes, including those described by sine wave and triangular zigzag or saw tooth functions, are referred to as serrations. However, theoretical calculations showed that the use of serrations in circular apertures provides only limited dampening of diffraction rings. The results of the calculations are shown in FIG. 8B, which provides the diffraction pattern of a serrated circular aperture, which is shown in FIG. 8A. For the calculations, the diameter of the aperture was set to 275 micrometers, and the viewing distance was set to 25 m. In order to improve visibility of the diffraction pattern in print, the contrast was enhanced by a factor of 2.5. In addition, experiments with serrated circular apertures showed additional high-frequency chromatic diffraction patterns that were absent from the non-serrated circular apertures. Furthermore, it was observed that, when electrically charged pigment particles that absorb light are used in a variable light transmission device having a channel with serrated edges, the particles penetrated into the serration at the open optical state. Thus, the serrations were obscured by the particles, reducing the mitigation of the diffraction patterns.

The inventors of the present invention discovered that the undesirable diffraction pattern observed at the open optical state can be mitigated using a variable light transmissive device having a microcell layer comprising a plurality of microcell, each microcell including an electrophoretic medium, each microcell having a channel, and a protrusion structure having one or more concavities. An example of a microcell of such variable light transmissive device is illustrated in FIGS. 2A-2C. That is, the mitigation of the undesirable diffraction pattern is achieved by a non-repeating transition of the optical density or the visible light spectra at the channel. The transition of optical density can be achieved by a specific architecture of the microcell, the channel having a complex shape.

In one example, the electrically charged particles of the electrophoretic medium of the variable light transmission device are light absorbing. The variable light transmission device comprises a plurality of microcells, each microcell comprising a channel and a protrusion structure having one or more concavities. The microcells comprise an electrophoretic medium with light absorbing electrically charged particles. The protrusion volume of the protrusion structure is a geometric solid, the geometric solid being a cone on a cylinder or other geometric solids. The protrusion volume may also be another geometric solid such as a polygonal pyramid, a polygonal pyramid frustum, a polygonal pyramid on an polygonal prism, a polygonal pyramid on a polygonal pyramid frustum, a first polygonal pyramid frustum on a second polygonal pyramid frustum, a cone, a conical frustum, a cone on a conical frustum, or a first conical frustum on a second conical frustum. In the open optical state of the device, the charged electrophoretic pigment particles are present in the microcell channel, which includes the concavities of the protrusion structure.

Various geometric solids of the protrusion volume are described below.
(a) a polygonal pyramid, the polygonal pyramid having an apex and a polygon base, the polygon base having from 3 to 20 sides, the polygon base being the protrusion base of the protrusion structure and the lower bases of the one or more concavities of the protrusion structure, the apex of the polygonal pyramid being the protrusion apex.
(b) a polygonal pyramid frustum, the polygonal pyramid frustum having a first polygon base and a second polygon base, the first polygon base of the polygonal pyramid frustum being the protrusion apex, the second polygon base of the polygonal pyramid frustum being the protrusion base and the lower bases of the one or more concavities of the protrusion structure, the first and second polygon bases of the polygonal pyramid frustum having from 3 to 20 sides.
(c) a polygonal pyramid on an polygonal prism, the polygonal pyramid having a polygon base, the polygon base of the polygonal pyramid having a surface area, the polygonal prism having a first polygon base and a second polygon base, the first polygon base having a surface area, the second polygon base having a surface area, the polygon base of the polygonal pyramid being in contact with the first polygon base of the polygonal prism, the surface area of the polygon base of the polygonal pyramid being the same as the surface area of the first polygon base of the polygonal prism, the polygon base of the polygonal pyramid and the first and second polygon bases of the polygonal prism having from 3 to 20 sides, the second polygon base of the polygonal prism being the protrusion base of the protrusion structure.
(d) a polygonal pyramid on a polygonal pyramid frustum, the polygonal pyramid having a polygon base, the polygon base of the polygonal pyramid having a surface area, the polygonal frustum having a first polygon base and a second polygon base, the first polygon base of the polygonal pyramid frustum having a first surface area, the second polygon base of the polygonal pyramid frustum having a second surface area, the polygon apex the polygonal pyramid being the protrusion apex, the polygon base of the polygonal pyramid being in contact with the first polygon base of the polygonal pyramid frustum, the surface area of the polygon base of the polygonal pyramid being the same as the first surface area of the first polygon base of the polygonal pyramid frustum, the second polygon base of the polygonal pyramid frustum being the protrusion base, the polygon base of the polygonal pyramid and the first and second polygon bases of the polygonal pyramid frustum having 3-20 sides.
(e) a first polygonal pyramid frustum on a second polygonal pyramid frustum, the first polygonal pyramid frustum having a first polygon base and a second polygon base, the first polygon base of the first polygonal pyramid frustum having a first surface area, the second polygon base of the first polygonal pyramid frustum having a second surface area, the second polygonal frustum having a first polygon base and a second polygon base, the first polygon base of the second polygonal pyramid frustum having a first surface area, the second polygon base of the second polygonal pyramid frustum having a second surface area, the first polygon base of the first polygonal pyramid frustum being the protrusion apex, the second polygon base of the first polygonal pyramid frustum being in contact with the first polygon base of the second polygonal pyramid frustum, the second surface area of the second polygon base of the first polygonal pyramid frustum being the same as the first surface area of the first polygon base of the second polygonal pyramid frustum, the second polygon base of the second polygonal pyramid frustum being the protrusion base, the first and second polygon base of the first polygonal pyramid frustum and the first and second polygon base of the second polygonal pyramid frustum having 3-20 sides.
(f) a cone, the cone having an apex and a base, the apex of the cone being the protrusion apex, the base of the cone being the protrusion base,
(g) a conical frustum, the conical frustum having a first base and a second base, the first base of the conical frustum being the protrusion apex, the second base of the conical frustum being the protrusion base.
(h) a cone on a cylinder, the cone having an apex and a base, the apex of the cone being the protrusion apex, the base of the cone having a surface area, the cylinder having a first base and a second base, the first base of the cylinder having a first surface area and the second base of the cylinder having a second surface area, the base of the cone being in contact with the first base of the cylinder, the surface area of the base of the cone being that same as the first surface area of the first base of the cylinder, the second base of the cylinder being the protrusion base.
(i) a cone on a conical frustum, the cone having an apex and a base, the apex of the cone being the protrusion apex, the base of the cone having a surface area, the conical frustum having a first base and a second base, the first base of the conical frustum having a surface area, the second base of the conical frustum having a surface area, the base of the cone being in contact with the first base of the conical frustum, the surface area of the base of the cone being the same as the surface area of the first base of the conical frustum, the second base of the conical frustum being the protrusion base.
(j) a first conical frustum on a second conical frustum, the first conical frustum having a first base and a second base, the first base of the first conical frustum having a first surface area, the second base of the first conical frustum having a second surface area, the first base of the first conical frustum being the protrusion apex, the second conical frustum having a first base and a second base, the first base of the second conical frustum having a first surface area, the second base of the second conical frustum having a second surface area, the second base of the first conical frustum being in contact with the first base of the second conical frustum, the second surface area of the first conical frustum being the same as the first surface area of the first base of the second conical frustum, the second base of the second conical frustum being the protrusion base.

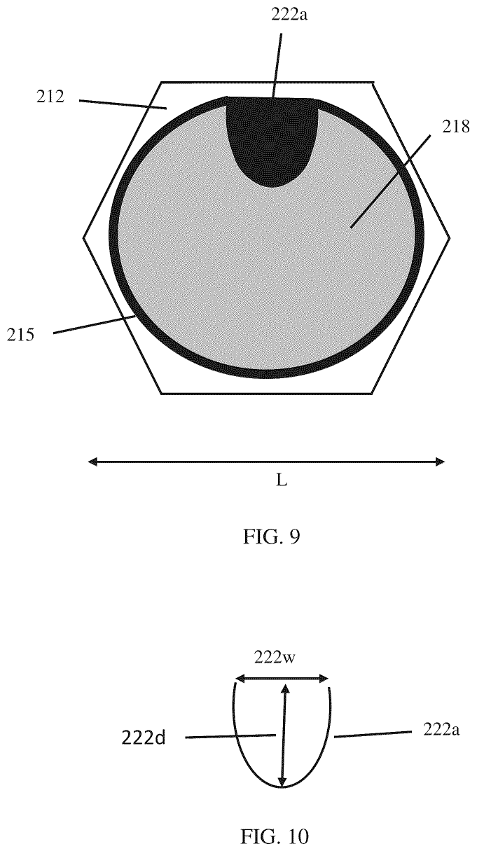

Each concavity of a protrusion structure has a lower base and an upper base. The lower base of the concavity is in contact with the exposed microcell bottom inside surface. The lower base of the concavity is in the same plane as the protrusion base of the protrusion structure. The upper base of the protrusion structure (218) is the intersection of the concavity with the exposed protrusion surface. FIG. 9 is an illustration of an example of a protrusion base of a microcell, the microcell having a hexagonal shape, the microcell having length L. The protrusion structure of this example has only one concavity. The protrusion volume is a cone. FIG. 9 also shows lower base of concavity 222a, microcell wall 212, and channel 215. The channel is depicted in black, and it includes the concavity. FIG. 10 illustrates different parts of the lower base of the concavity (222a), such as depth of concavity 222d and width of concavity 222a.

FIG. 11 is an illustration of an example of a protrusion base of a microcell, the microcell having a hexagonal shape, the microcell having length L. The protrusion structure of this example has two concavities. The protrusion volume of the protrusion structure (which includes the concavity) is a cone. FIG. 11 shows the lower base of the two concavities 222a, microcell wall 212, and channel 215. The channel in which the electrophoretic particles are present in the open optical state is depicted in black and it includes the two concavities. The bases of the two concavities in this example are arranged along the base of the concavity at an angle of 180 degrees to each other. Thus, in this example, the lower bases (222a) of all concavities of the protrusion structure have a C2 symmetry about a symmetry axis, the symmetry axis being vertical to the plane of the protrusion base (218) and passing through the center of the protrusion base. C2 symmetry means that rotation around the symmetry axis through an angle of 180 degrees (360/2) leaves the lower bases (222a) of the concavities of the protrusion structure indistinguishable from the lower bases of the concavities before the rotation.

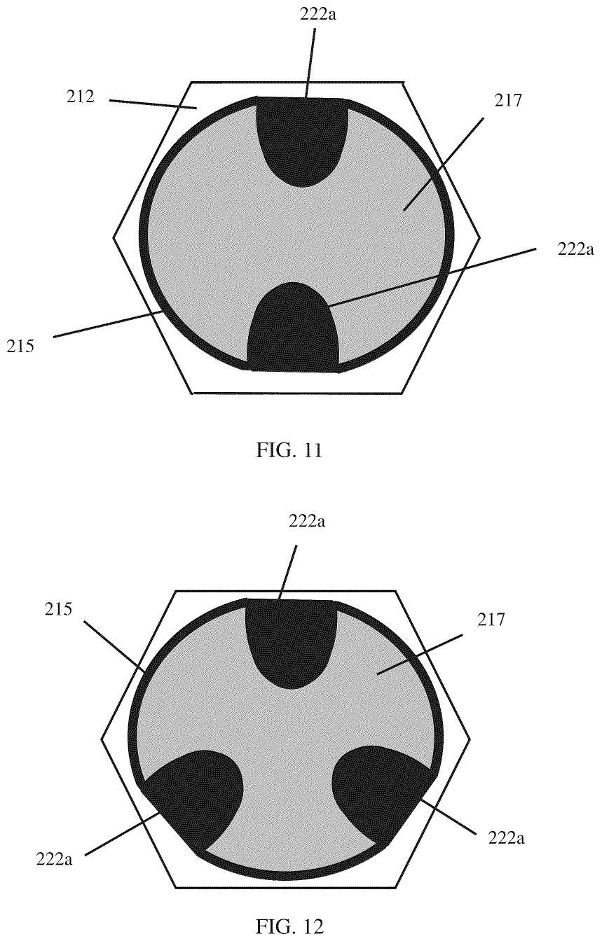

FIG. 12 is an illustration of an example of a protrusion base of a microcell, the microcell having a hexagonal shape, the microcell having length L. The protrusion structure of this example has three concavities. The protrusion volume of the protrusion is a cone. FIG. 12 shows the lower base of the lower bases of the three concavities 222a, microcell wall 212, and channel 215. The channel is depicted in black. The lower bases of the three concavities in this example are arranged along the base of the concavity at an angle of 120 degrees to each other. Thus, in this example, the lower bases (222a) of all concavities of the protrusion structure have a C3 symmetry about a symmetry axis, the symmetry axis being vertical to the plane of the protrusion base (218) and passing through the center of the protrusion base. C3 symmetry means that rotation around the symmetry axis through an angle of 120 degrees (360/3) leaves the lower bases (222a) of the concavities of the protrusion structure indistinguishable from the lower bases of the concavities before the rotation. In general, if the protrusion structure has n concavities, and the concavities are arranged symmetrically around the protrusion structure, it can be said that the lower bases (222a) of all concavities of the protrusion structure have a Cn symmetry about a symmetry axis, the symmetry axis being vertical to the plane of the protrusion base (218) and passing through the center of the protrusion base. Cn symmetry means that rotation around the symmetry axis through an angle of 360/n degrees leaves the lower bases (222a) of the concavities of the protrusion structure indistinguishable from the lower bases of the concavities.

The variable light transmission device may comprise a microcell, the lower bases (222a) of all concavities of the protrusion structure (217) of the microcell lacking a Cn symmetry about a symmetry axis, the symmetry axis being vertical to the plane of the protrusion base (218) and passing through the center of the protrusion base. The variable light transmission device may comprise more than one such microcell. All the microcells of the variable light transmission device may also show lack of such symmetry.

The diffraction patterns observed in the open state of variable light transmission devices are mitigated by forming complex shapes of microcell channel, as shown in FIGS. 9-12. Mitigation can also be achieved by variable light transmission devices comprising a microcell layer comprising a plurality of microcells having microcells with 1 to 6 concavities. The variable light transmission device may have two types of microcells, a first type and a second type, the first type having a protrusion structure with m concavities and the second type having a protrusion structure having p concavities, where m and p are integers and m is different from p. For example, m may be 1 and p may be 2 or 3. The variable light transmission device may have three types of microcells, a first type, a second type, and a third type. The first type of microcells has a protrusion structure with m concavities, the second type of microcells has a protrusion structure with p concavities, and the third type of microcells has a protrusion structure with q concavities, where m, p, and q are integers, m is different from p and q, and p is different from q. For example, m may be 1, p may be 2, and q may be 3. The parameters m, p, and q represent the number of concavities in the protrusion structure of the first, second, and third types of microcells. Integers m, p, and q may be from 1 to 10, or from 1 to 8, or from 1 to 6, or from 1 to 4, or from 1 to 3.

Mitigation can also be achieved by variable light transmission devices comprising two microcells that lack C2 symmetry to each other about an axis. Specifically, a variable light transmission device may comprise a first microcell and a second microcell. The first microcell may comprise a first protrusion structure having a first protrusion base and 1, 2, 3, 4, 5, or 6 concavities, each concavity having a lower base, the combination of the first protrusion base and the lower bases of the concavities of the first microcell forming a first geometric shape, the first geometric shape having a first center. The second microcell may comprise a second protrusion structure having a second protrusion base and 1, 2, 3, 4, 5, or 6 concavities, each concavity having a lower base, the combination of the second protrusion base and the lower bases of the concavities of the second microcell forming a second geometric shape, the second geometric shape having a second center. The first protrusion base may lack C2 symmetry to the second protrusion base about a symmetry axis, the symmetry axis being vertical to the plane of the first protrusion base, the symmetry axis passing through a point that is the middle of the distance between the first centers and the second center. C2 symmetry of the first protrusion base to the second protrusion base means that rotation around the symmetry axis through an angle of 180° leaves the first and second protrusion bases indistinguishable from the first and second protrusion bases before the rotation. The variable light transmission devices of the above example may further comprise a third microcell. The third microcell may comprise a third protrusion structure having a third protrusion base and 1, 2, 3, 4, 5, or 6 concavities, each concavity having a lower base, the combination of the third protrusion base and the lower bases of the concavities of the third microcell forming a third geometric shape, the third geometric shape having a third center. The third protrusion base may lack C2 symmetry to the first protrusion base about a symmetry axis, the symmetry axis being vertical to the plane of the first protrusion base, the symmetry axis passing through a point that is the middle of the distance between the first center and the third center. The third protrusion base may also lack C2 symmetry to the second protrusion base about a symmetry axis, the symmetry axis being vertical to the plane of the second protrusion base, the symmetry axis passing through a point that is the middle of the distance between the second center and the third center. The variable light transmission device may have multiple microcells having protrusion structures, wherein the protrusion bases of each other lack this kind of symmetry.

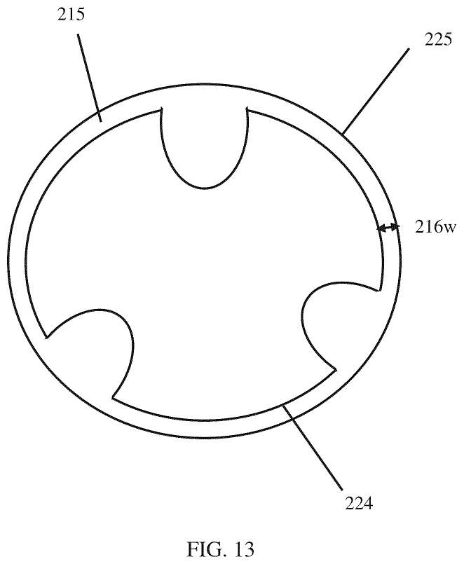

FIG. 13 is a top view of the microcell shown in FIG. 12. The protrusion structure of FIG. 12 has three concavities. FIG. 13 clearly depicts channel 215 of the microcell, where electrophoretic pigment particles reside at the open optic state. Channel 216 has an inner base perimeter 224 and an outer base perimeter 225. Channel 216 also has a channel width 216w, which is the smallest distance between the inner base perimeter and outer base perimeter of a channel. As mentioned before, channel 215, which includes the volume of the concavities, is the location where electrophoretic particles are present at the open optical state of the variable light transmissive device.

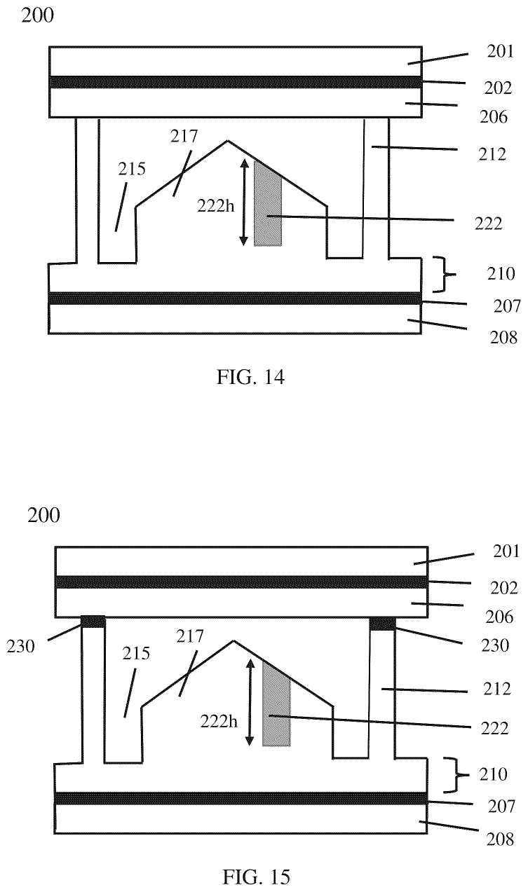

FIG. 14 illustrates a side view of a microcell of a variable light transmission device 200 of the present invention comprising light transmissive substrate 201, first light transmissive electrode layer 202, microcell layer comprising a plurality of microcells and a sealing layer 206, second light transmissive layer 207, and second light transmissive substrate 208. The microcell comprises microcell walls 212, channel 215, protrusion structure 217, concavity 222, and microcell bottom 210. The concavity height 222h is also shown in FIG. 14. The microcells of the variable light transmission device 200 of the present invention may also comprise a light blocking layer 230, which is shown in FIG. 15. Light blocking layer 230 is disposed between the microcell upper surface and scaling layer 206. Light blocking layer 230 may comprise a light absorbing pigment. The light absorbing pigment of the light blocking layer may have black color. The inventors of the present invention found that light blocking layer 230 contributes to an improved closed state by increasing the opacity of the device that may be caused by a partially light transmissive wall material. Light blocking layer 230 may be electrically conductive, which may facilitate the switching of the device.

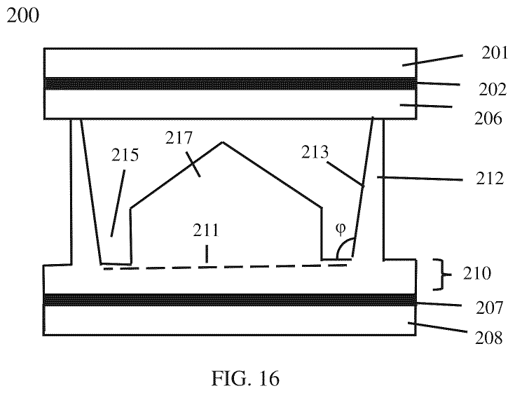

FIG. 16 illustrates a microcell of a variable light transmission device 200 of the present invention comprising light transmissive substrate 201, first light transmissive electrode layer 202, microcell layer comprising a plurality of microcells and a sealing layer 206, second light transmissive layer 207, and second light transmissive substrate 208. The microcell comprises microcell walls 212, channel 215, protrusion structure 217, and microcell bottom 210. The concavity (or concavities) of the protrusion structure is not shown in FIG. 16). In the microcell of the variable light transmission device of FIG. 16, the microcell inside wall surface (213) forms an angle (φ) with microcell bottom inside surface (211), the angle being larger than 90 degrees. The inventors of the present invention found that such a structure significantly facilitates the embossing process for the making of the plurality of microcells, by enabling smooth removal of the embossing tool that does not damage the microcell walls. Angle φ may be from 90 to 120 degrees, 93 to 117 degrees, 95 to 115 degrees, 98 to 118 degrees, or 100 to 115 degrees.

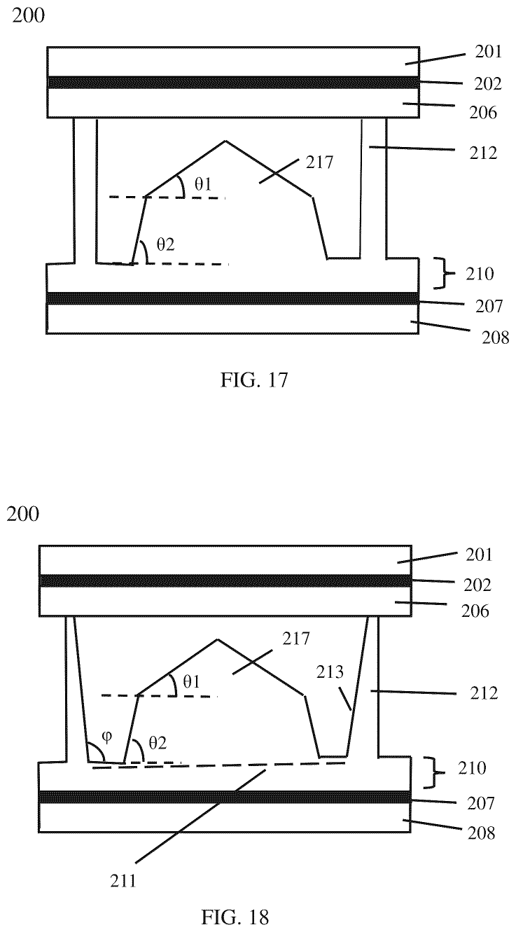

Another element that facilitates the process of making the device is shown in FIG. 17, which illustrates a microcell of variable light transmission device 200 of the present invention. The device comprises light transmissive substrate 201, first light transmissive electrode layer 202, microcell layer comprising a plurality of microcells and a sealing layer 206 (herein only one microcell of the plurality of microcells is shown), second light transmissive layer 207, and second light transmissive substrate 208. The microcell comprises microcell walls 212, protrusion structure 217, and microcell bottom 210. The concavity (or concavities) of the protrusion structure is not shown in FIG. 17). The protrusion volume of the protrusion structure is a geometric solid, which is a cone on a conical frustum. The cone has a first slope (θ1), and the conical frustum has a second slope (θ2). The second slope (θ2) is larger than the first slope (θ1), and the difference between the second slope (θ2) and the first slope (θ1) is from 1 to 25 degrees, from 1 to 30 degrees, from 2 to 20 degrees, from 2 to 15 degrees, from 2 to 12 degrees, from 2 to 9 degrees, from 2 to 8 degrees, from 3 to 8 degrees, or from 4 to 8 degrees.

FIG. 18 illustrates a microcell of a variable light transmission device 200 of the present invention, which enables an even easier process of making the device. The variable light transmission device comprises light transmissive substrate 201, first light transmissive electrode layer 202, microcell layer comprising a plurality of microcells and a sealing layer 206 (herein only one microcell of the plurality of microcells is shown), second light transmissive layer 207, and second light transmissive substrate 208. The microcell comprises microcell walls 212, protrusion structure 217, and microcell bottom 210. The protrusion structure has a similar structure as this of FIG. 17 (cone on a conical frustum) with the slope of the conical frustum θ2 (second slope) being larger than the slope θ1 (first slope) of the conc. The difference between the second slope (θ2) and the first slope (θ1) is from 1 to 25 degrees, from 1 to 30 degrees, from 2 to 20 degrees, from 2 to 15 degrees, from 2 to 12 degrees, from 2 to 9 degrees, from 2 to 8 degrees, from 3 to 8 degrees, or from 4 to 8 degrees. Furthermore, in the device of FIG. 18, the microcell inside wall surface (213) forms an angle (φ) with microcell bottom inside surface (211), the angle being larger than 90 degrees, as shown in the structure of the device illustrated in FIG. 16. Angle φ may be from 90 to 120 degrees, 93 to 117 degrees, 95 to 115 degrees, 98 to 118 degrees, or 100 to 115 degrees.

FIG. 19B shows the Fraunhofer diffraction patterns formed by a variable light transmission device according to the present invention. The variable light transmission device is illustrated in FIG. 19A, and it comprises a plurality of microcells having a protrusion structure and a channel, the protrusion structure having three concavities. The protrusion volume of the protrusion structure is a cone on a cylinder. FIG. 19A is a bottom view of the protrusion bases and the lower bases of the concavities of 10 microcells. The concavities have a C3 symmetry within each microcell. However, the sets of three concavity of the various microcells are oriented towards different direction for the different microcells. That is, the variable light transmission device of FIG. 19A comprises a microcell layer comprising a set of three or more microcells, each of the set of the three or more microcells having a protrusion base, wherein each one of the protrusion bases has no C2 symmetry about a symmetry axis to a protrusion base of any microcell of the microcell set of the three or more microcells. Here, C2 symmetry means that rotation around the symmetry axis through an angle of 1800 leaves the protrusion bases of the set of the three or more microcells indistinguishable from the protrusion bases before the rotation. For a set of two protrusion bases of two microcells, the symmetry axis is vertical to the plane of one of the protrusion bases and passes through a point that is the middle of the distance between the centers of the geometric shapes formed by the combination of the protrusion base and the lower bases of the concavities for each microcell. This construction of the microcell layer decreases the symmetry of the microcell layer as a whole, mitigating the effect of Fraunhofer diffraction patterns.

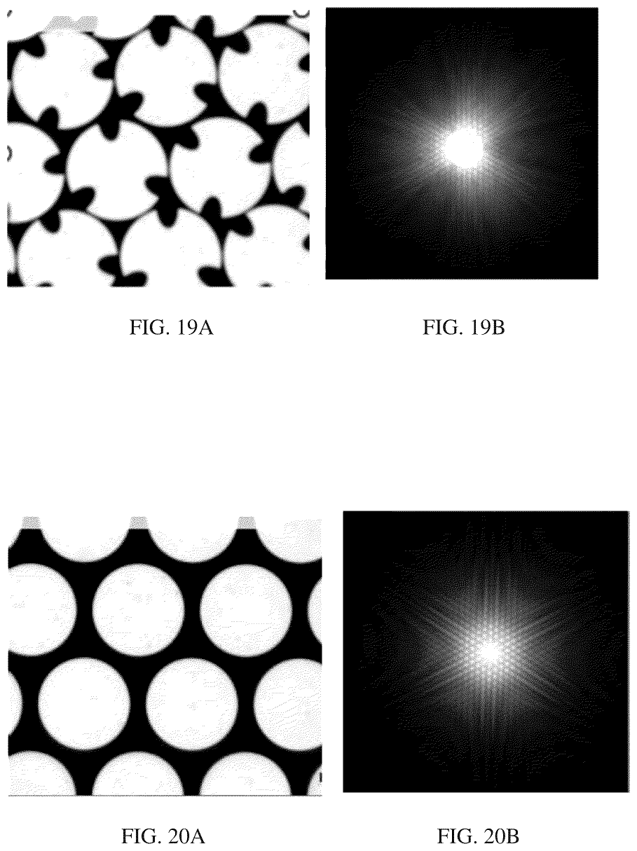

FIG. 20B shows the Fraunhofer diffraction patterns formed by a variable light transmission device comprising a microcell layer comprising a plurality of microcell. Each microcell comprises a protrusion structure (cone on cylinder) having no concavities. The channel has circular profile. FIG. 20A is a bottom view of a portion of the microcell layer, wherein protrusion bases are shown as circles.

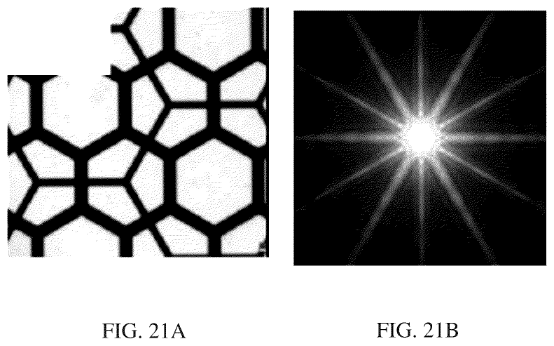

FIG. 21B shows the Fraunhofer diffraction patterns formed by a variable light transmission device comprising a microcell layer comprising a plurality of microcell, each microcell having a protrusion structure. Each microcell and its channel have a hexagonal shape, as shown in FIG. 21A, which is a bottom view of a portion of the microcell layer.

The images of FIGS. 19B, 20B, and 21B demonstrate that the variable light transmission device of the present invention, which is shown in FIG. 19A, effectively mitigates Fraunhofer diffraction patterns caused by device apertures.

Parts of the structures in the drawings: 200 variable light transmission device; 201 first light transmissive substrate; 202 first light-transmissive electrode layer; 203 microcell layer; 204 plurality or microcells; 205 microcell opening; 206 sealing layer; 207 second light-transmissive electrode layer; 208 second light transmissive substrate; 209 electrophoretic medium; 210 microcell bottom layer; 211 microcell bottom inside surface; 211a exposed microcell bottom inside surface; 211b unexposed microcell bottom inside surface; 212 microcell walls; 213 microcell inside wall surface; 214 microcell wall upper surface; 125 channel; 216h channel height; 216w channel width; 217 protrusion structure; 218 protrusion base; 219 protrusion apex; 220 protrusion height; 221 exposed protrusion surface; 222 concavity; 222a lower base of concavity; 222h height of concavity; 222d depth pf concavity; 222w width of concavity; 223 electrically charged pigment particles; 224 inner base perimeter of channel; 225 outer base perimeter of channel; 230 light blocking layer; 250 first outside surface of variable light transmission device; 251 second outside surface of variable light transmission device.

The invention claimed is:

1. A variable light transmission device (200) comprising:
a first light transmissive electrode layer (202);
a second light transmissive electrode layer (207); and
a microcell layer (203), the microcell layer (203) being disposed between the first light transmissive electrode layer (202) and the second light transmissive electrode layer (207), the microcell layer (203) comprising a plurality of microcells (204) and a sealing layer (206);
each microcell of the plurality of microcells (204) including an electrophoretic medium (209), the electrophoretic medium (209) comprising electrically charged pigment particles (223), a charge control agent, and a non-polar liquid;
each microcell of the plurality of microcells (204) having a microcell opening (205), the sealing layer (206) spanning the microcell openings (205) of the plurality of microcells (204);
the sealing layer (206) of each microcell having an upper surface and a lower surface, the upper surface being in contact with the first light transmissive electrode layer (202) and the lower surface being in contact with the electrophoretic medium (209);
each microcell of the plurality of microcells (204) comprising a microcell bottom layer (210), a protrusion structure (217), microcell walls (212), and a channel (215), the microcell bottom layer (210) having a microcell bottom inside surface (211), the microcell bottom inside surface (211) comprising an exposed microcell bottom inside surface (211a) and an unexposed microcell bottom inside surface (211b);
the protrusion structure (217) having a protrusion base (218), a total protrusion surface, an exposed protrusion surface (221), a protrusion apex (219), a protrusion height (220), a protrusion volume, and one or more concavities (222), the protrusion base having a surface, the protrusion apex (219) being a point or a set of points of the protrusion structure (217), the point or the set of points having shorter distance from the microcell opening (205) than all other points of the protrusion structure (217), the protrusion apex (219) having a distance from the protrusion base (218), the protrusion apex (219) having a surface if the protrusion apex (219) is a set of point, the protrusion height (220) being the distance between the protrusion base (218) and the protrusion apex (219), the exposed protrusion surface (221) being the total protrusion surface (i) the surface of the protrusion base and (ii) any part of the surface of the protrusion apex, the exposed protrusion surface (221) being in contact with the electrophoretic medium (209), the unexposed microcell bottom inside surface (211b) being in contact with the protrusion base (218), and the exposed microcell bottom inside surface (211a) being in contact with the electrophoretic medium (209);
the microcell walls (212) having a microcell inside wall surface (213) and a microcell wall upper surface (214), the microcell inside wall surface (213) being a surface of the microcell walls (212) of a microcell that is in contact with the electrophoretic medium (209), the microcell wall upper surface (214) being a surface of the microcell walls (212) that is in contact with the sealing layer (206);
the channel (215) having a channel height (216h), an inner base perimeter (224), and an outer base perimeter (225), the channel height (216h) being 50% of the protrusion height (220), the inner base perimeter (224) being the intersection of the microcell wall (212) and the exposed microcell bottom inside surface (211), the outer base perimeter (225) being the intersection of the protrusion base and the exposed microcell bottom inside surface;
the channel (215) being a volume that is defined by the exposed microcell bottom inside surface (211a), the exposed protrusion surface (221), the microcell inside wall surface (213) and a plane that is parallel to the microcell bottom inside surface (211), the plane having a distance from the microcell bottom inside surface (211) equal to the channel height (216h);
the variable light transmission device (200) having a first outside surface (250) and a second outside surface (251), the first outside surface (250) being located on a side of the variable light transmission device that is near the first light transmissive electrode layer (202), and the second outside surface (251) being located on a side of the variable light transmission device that is near the second light transmissive electrode layer (207);
each concavity (222) of the one or more concavities of the protrusion structure (217) being a geometric solid, the geometric solid of each concavity (222) of the one or more concavities having a volume, a height (222h), a depth (222d), and a width (222w), the geometric solid of each concavity (222) of the one or more concavities having a upper base (222b), a lower base (222a), and a peripheral surface, the lower base of each concavity (222a) of the one or more concavities being in contact with the exposed microcell bottom inside surface (211a), the lower base of each concavity (222a) of the one or more concavities having a shape selected from the group consisting of an oval, an oval segment, an oval sector, a circular segment, a circular sector, a triangle, a square, a rectangle, or a polygon having from 5 to 20 sides, each concavity (222) of the one or more concavities being occupied by the electrophoretic medium (209) of the variable light transmission device (200), the protrusion volume of the protrusion structure (217) is a geometric solid, the geometric solid being selected from the group consisting of
(a) a polygonal pyramid, the polygonal pyramid having an apex and a polygon base, the polygon base having from 3 to 20 sides, the polygon base being the protrusion base (218) of the protrusion structure (217) and the lower bases (222a) of the one or more concavities (222) of the protrusion structure (217), the apex of the polygonal pyramid being the protrusion apex (219),
(b) a polygonal pyramid frustum, the polygonal pyramid frustum having a first polygon base and a second polygon base, the first polygon base of the polygonal pyramid frustum being the protrusion apex (219), the second polygon base of the polygonal pyramid frustum being the protrusion base (218) and the lower bases (222a) of the one or more concavities (222) of the protrusion structure (217), the first and second polygon bases of the polygonal pyramid frustum having from 3 to 20 sides,
(c) a polygonal pyramid on an polygonal prism, the polygonal pyramid having a polygon base, the polygon base of the polygonal pyramid having a surface area, the polygonal prism having a first polygon base and a second polygon base, the first polygon base having a surface area, the second polygon base having a surface area, the polygon base of the polygonal pyramid being in contact with the first polygon base of the polygonal prism, the surface area of the polygon base of the polygonal pyramid being the same as the surface area of the first polygon base of the polygonal prism, the polygon base of the polygonal pyramid and the first and second polygon bases of the polygonal prism having from 3 to 20 sides, the second polygon base of the polygonal prism being the protrusion base (218) of the protrusion structure (217),
(d) a polygonal pyramid on a polygonal pyramid frustum, the polygonal pyramid having a polygon base, the polygon base of the polygonal pyramid having a surface area, the polygonal frustum having a first polygon base and a second polygon base, the first polygon base of the polygonal pyramid frustum having a first surface area, the second polygon base of the polygonal pyramid frustum having a second surface area, the polygon apex the polygonal pyramid being the protrusion apex (219), the polygon base of the polygonal pyramid being in contact with the first polygon base of the polygonal pyramid frustum, the surface area of the polygon base of the polygonal pyramid being the same as the first surface area of the first polygon base of the polygonal pyramid frustum, the second polygon base of the polygonal pyramid frustum being the protrusion base (218), the polygon base of the polygonal pyramid and the first and second polygon bases of the polygonal pyramid frustum having 3-20 sides,
(e) a first polygonal pyramid frustum on a second polygonal pyramid frustum, the first polygonal pyramid frustum having a first polygon base and a second polygon base, the first polygon base of the first polygonal pyramid frustum having a first surface area, the second polygon base of the first polygonal pyramid frustum having a second surface area, the second polygonal frustum having a first polygon base and a second polygon base, the first polygon base of the second polygonal pyramid frustum having a first surface area, the second polygon base of the second polygonal pyramid frustum having a second surface area, the first polygon base of the first polygonal pyramid frustum being the protrusion apex (219), the second polygon base of the first polygonal pyramid frustum being in contact with the first polygon base of the second polygonal pyramid frustum, the second surface area of the second polygon base of the first polygonal pyramid frustum being the same as the first surface area of the first polygon base of the second polygonal pyramid frustum, the second polygon base of the second polygonal pyramid frustum being the protrusion base (218), the first and second polygon base of the first polygonal pyramid frustum and the first and second polygon base of the second polygonal pyramid frustum having 3-20 sides,
(f) a cone, the cone having an apex and a base, the apex of the cone being the protrusion apex (219), the base of the cone being the protrusion base (218),
(g) a conical frustum, the conical frustum having a first base and a second base, the first base of the conical frustum being the protrusion apex (219), the second base of the conical frustum being the protrusion base (218),
(h) a cone on a cylinder, the cone having an apex and a base, the apex of the cone being the protrusion apex (219), the base of the cone having a surface area, the cylinder having a first base and a second base, the first base of the cylinder having a first surface area and the second base of the cylinder having a second surface area, the base of the cone being in contact with the first base of the cylinder, the surface area of the base of the cone being that same as the first surface area of the first base of the cylinder, the second base of the cylinder being the protrusion base (218),
(i) a cone on a conical frustum, the cone having an apex and a base, the apex of the cone being the protrusion apex (219), the base of the cone having a surface area, the conical frustum having a first base and a second base, the first base of the conical frustum having a surface area, the second base of the conical frustum having a surface area, the base of the cone being in contact with the first base of the conical frustum, the surface area of the base of the cone being the same as the surface area of the first base of the conical frustum, the second base of the conical frustum being the protrusion base (218),
(j) a first conical frustum on a second conical frustum, the first conical frustum having a first base and a second base, the first base of the first conical frustum having a first surface area, the second base of the first conical frustum having a second surface area, the first base of the first conical frustum being the protrusion apex (219), the second conical frustum having a first base and a second base, the first base of the second conical frustum having a first surface area, the second base of the second conical frustum having a second surface area, the second base of the first conical frustum being in contact with the first base of the second conical frustum, the second surface area of the first conical frustum being the same as the first surface area of the first base of the second conical frustum, the second base of the second conical frustum being the protrusion base (218);
wherein application of a first electric field between the first light transmissive electrode layer (202) and the second light transmissive electrode layer (207) via a first waveform causes movement of the electrically charged pigment particles (223) towards the channel (215), resulting in switching of the variable light transmission device (200) to an open optical state;
wherein application of a second electric field between the first light transmissive electrode layer (202) and the second light transmissive electrode layer (207) via a second waveform causes a movement of the electrically charged pigment particles (223) towards the first light transmissive electrode layer (202), wherein the closed optical state has lower percent transparency than the open optical state.

2. The variable light transmission device of claim 1, wherein the protrusion structure (217) of a microcell of the microcell layer has six or less concavities (222).

3. The variable light transmission device of claim 1, wherein the microcell opening (205) of each microcell of the plurality of microcells (204) of the microcell layer (203) has a shape, the shape of the microcell opening (205) being selected from the group consisting of a circle, a square, a rectangle, and a polygon, the polygon having 5 to 12 sides.

4. The variable light transmission device of claim 1, wherein each microcell of the plurality of microcells (204) has a length of from 400 micrometers to 800 micrometers and a height of from 20 micrometers to 100 micrometers.

5. The variable light transmission device of claim 1, wherein the channel (215) has a width of from 10 micrometers to 30 micrometers.

6. The variable light transmission device of claim 1, wherein the protrusion height (220) is from 15 micrometers to 90 micrometers, and wherein the one or more concavities (222) of the protrusion structure (217) have a depth (222d) of from 10 micrometers to 40 micrometers and a width (222w) of from 10 micrometers to 40 micrometers.

7. The variable light transmission device of claim 1, wherein the variable light transmission device comprises a microcell having a protrusion structure (217) with 2, 3, 4, 5 or 6 concavities (222), the combination of the protrusion base and the lower bases of the concavities of the microcell forming a first geometric shape, the first geometric shape having a center, wherein the protrusion base (218) has a Cn symmetry about a symmetry axis, the symmetry axis being vertical to the plane of the protrusion base (218) and passing through the center of the first geometric shape, n being the number of the concavities (222) of the protrusion structure, and wherein Cn symmetry means that rotation around the symmetry axis through an angle of 360°/n leaves the protrusion base (218) indistinguishable from the protrusion base (218) before the rotation.

8. The variable light transmission device of claim 1, wherein the variable light transmission device comprises a microcell having a protrusion structure (217) with 2, 3, 4, 5, or 6 concavities (222), the combination of the protrusion base and the lower bases of the concavities of the microcell forming a first geometric shape, the first geometric shape having a center, wherein the protrusion base (218) does not have a Cn symmetry about a symmetry axis, the symmetry axis being vertical to the plane of the protrusion base (218) and passing through the center of the first geometric shape, n being the number of the concavities (222) of the protrusion structure (217), and wherein Cn symmetry means that rotation around the symmetry axis through an angle of 360°/n leaves the protrusion base (218) of the protrusion structure indistinguishable from the protrusion base (218) before the rotation.

9. The variable light transmission device of claim 1, the variable light transmission device comprising a first microcell and a second microcell, the first microcell comprising a first protrusion structure having a first protrusion base and 1, 2, 3, 4, 5, or 6 concavities, each concavity having a lower base, the combination of the first protrusion base and the lower bases of the concavities of the first microcell forming a first geometric shape, the first geometric shape having a first center, the second microcell comprising a second protrusion structure having a second protrusion base and 1, 2, 3, 4, 5, or 6 concavities, each concavity having a lower base, the combination of the second protrusion base and the lower bases of the concavities of the second microcell forming a second geometric shape, the second geometric shape having a second center, wherein the first protrusion base has no C2 symmetry to the second protrusion base about a symmetry axis, the symmetry axis being vertical to the plane of the first protrusion base, the symmetry axis passing through a point that is the middle of the distance between the first centers and the second center, and wherein C2 symmetry of the first protrusion base to the second protrusion base means that rotation around the symmetry axis through an angle of 180° leaves the first and second protrusion bases indistinguishable from the first and second protrusion bases before the rotation.

10. The variable light transmission device of claim 9, wherein the variable light transmission device comprises a third microcell, the third microcell comprising a third protrusion structure having a third protrusion base and 1, 2, 3, 4, 5, or 6 concavities, each concavity having a lower base, the combination of the third protrusion base and the lower bases of the concavities of the third microcell forming a third geometric shape, the third geometric shape having a third center, wherein the third protrusion base has no C2 symmetry to the first protrusion base about a symmetry axis, the symmetry axis being vertical to the plane of the first protrusion base, the symmetry axis passing through a point that is the middle of the distance between the first center and the third center, and wherein the third protrusion base has no C2 symmetry to the second protrusion base about a symmetry axis, the symmetry axis being vertical to the plane of the second protrusion base, the symmetry axis passing through a point that is the middle of the distance between the second center and the third center.

11. The variable light transmission device of claim 1, wherein the geometric solid of the protrusion volume of the protrusion structure (217) of a microcell is a polygonal pyramid on a polygonal pyramid frustum, the polygonal pyramid having a first slope (θ1), and the pyramid frustum having a second slope (θ2), the second slope (θ2) being larger than the first slope (θ1), and the difference between the second slope (θ2) and the first slope (θ1) being from 1 to 25 degrees, or wherein the geometric solid of the protrusion volume of the protrusion structure (217) is a first polygonal pyramid frustum on a second polygonal pyramid frustum, the first polygonal pyramid frustum having a first slope (θ1), and the second pyramid frustum having a second slope (θ2), the second slope (θ2) being larger than the first slope (θ1), and the difference between the second slope (θ2) and the first slope (θ1) being from 1 to 25 degrees.

12. The variable light transmission device of claim 1, wherein the geometric solid of the protrusion volume of the protrusion structure (217) of a microcell is a cone on a conical frustum, the cone having a first slope (θ1) and the conical frustum having a second slope (θ2), the second slope (θ2) being larger than the first slope (θ1), and the difference between the second slope (θ2) and the first slope (θ1) being from 1 to 25 degrees, or wherein the geometric solid is a first conical frustum on a second conical frustum, the first conical frustum having a first slope (θ1) and the second conical frustum having a second slope (θ2), the second slope (θ2) being larger than the first slope (θ1), and the difference between the second slope (θ2) and the first slope (θ1) being from 1 to 25 degrees.

13. The variable light transmission device of claim 1, wherein the variable light transmission device comprises one or more microcells having an inside wall surface (213) and a microcell bottom surface (211), the inside wall surface (213) and the microcell bottom surface (211) forming an angle (φ), the angle (φ) being from 90 to 120 degrees.

14. The variable light transmission device of claim 1, wherein the variable light transmission device comprises a first adhesive layer and a second adhesive layer, the first adhesive layer being disposed between the sealing layer (206) and the first light transmissive electrode layer (202), and the second adhesive layer being disposed between the microcell layer (203) and the second light transmissive electrode layer (207).

15. The variable light transmission device of claim 1, wherein variable light transmission device comprises a light blocking layer (230) disposed between the microcell upper surface (214) and the sealing layer (206), the light blocking layer (230) comprising light absorbing pigment.

16. The variable light transmission device of claim 15, wherein the light absorbing pigment of the light blocking layer (230) has black color.

17. The variable light transmission device of claim 1, wherein the electrically charged pigment particles (223) of the electrophoretic medium (209) are light absorbing.

18. The variable light transmission device of claim 1, wherein the second electric field causes a movement of the electrically charged pigment particles (223) towards the first light transmissive electrode layer (202) with a velocity, the velocity having a lateral component.

19. The variable light transmission device of claim 1, wherein the second waveform comprises at least one positive voltage and at least one negative voltage, the second waveform having a net positive or net negative impulse.

20. The variable light transmission device of claim 19, wherein the second waveform comprises an AC waveform, the AC waveform having a duty cycle of from 5% to 45%, or wherein the second waveform comprises a DC-offset waveform, which is formed by a superposition of a DC voltage component and an AC waveform.
